(19) United States
(12) Patent Application Publication
(10) Pub. No.: US 2022/0398530 A1
(43) Pub. Date: Dec. 15, 2022

(54) BUSINESS SUPPORT DEVICE, BUSINESS SUPPORT METHOD, COMPUTER PROGRAM, AND BUSINESS SUPPORT SYSTEM

(71) Applicant: PANASONIC INTELLECTUAL PROPERTY MANAGEMENT CO., LTD., Osaka (JP)

(72) Inventors: Ayaka NAKAJIMA, Kanagawa (JP); Bilguun SAINBAYAR, Kanagawa (JP); Tetsurou KAKIZAWA, Kanagawa (JP)

(73) Assignee: PANASONIC INTELLECTUAL PROPERTY MANAGEMENT CO., LTD., Osaka (JP)

(21) Appl. No.: 17/777,435

(22) PCT Filed: Nov. 9, 2020
(86) PCT No.: PCT/JP2020/041769

§ 371 Date: May 17, 2022

(30) Foreign Application Priority Data
Nov. 18, 2019 (JP) 2019-207988

(51) Int. Cl. G06Q 10/08; G06Q 30/06; G06V 20/52; A47F 5/00

(52) U.S. Cl. CPC G06Q 10/087; G06Q 30/0639; G06V 20/52; A47F 5/00

(57) ABSTRACT

A business support device includes: a storage unit that stores an appearance image of an article included in a first shelf image obtained by capturing an image of a display shelf of the article and a position of an arrangement of the article indicated by the appearance image on the display shelf in association with each other; and a processing unit configured to detect the appearance image stored in the storage unit from a second shelf image obtained by capturing an image of the display shelf after the first shelf image is obtained, and control a notification related to the arrangement of the article indicated by the appearance image based on a detection result thereof.

### TECHNICAL FIELD

The present disclosure relates to a business support device, a business support method, a computer program, and a business support system.

### BACKGROUND ART

In the related art, there is known a technique in which a camera device captures an image of a shelf on which commodities are displayed in a store (hereinafter referred to as a “display shelf”), and a captured image is analyzed to determine whether a commodity is out of stock in the display shelf (Patent Literature 1).

### CITATION LIST

### Patent Literature

Patent Literature 1: WO-A1-2019/087519

### SUMMARY OF INVENTION

### Technical Problem

However, Patent Literature 1 only detects stockout of a commodity in the display shelf, and does not refer to improvement in efficiency of a business when stockout is detected.

An object of the present disclosure is to provide a technique for improving the efficiency of a business when stockout occurs in a display shelf.

### Solution to Problem

A business support device according to an aspect of the present disclosure includes: a storage unit that stores an appearance image of an article included in a first shelf image obtained by capturing an image of a display shelf of the article and a position of an arrangement of the article indicated by the appearance image on the display shelf in association with each other; and a processing unit configured to detect the appearance image stored in the storage unit from a second shelf image obtained by capturing an image of the display shelf after the first shelf image is obtained, and control a notification related to the arrangement of the article indicated by the appearance image based on a detection result.

A business support method according to an aspect of the present disclosure includes: by a device, storing, in a storage unit, an appearance image of an article included in a first shelf image obtained by capturing an image of a display shelf of the article and a position of an arrangement of the article indicated by the appearance image on the display shelf in association with each other; and detecting the appearance image stored in the storage unit from a second shelf image obtained by capturing an image of the display shelf after the first shelf image is obtained, and controlling a notification related to the arrangement of the article indicated by the appearance image based on a detection result.

A computer program according to an aspect of the present disclosure causes a computer to execute: storing, in a storage unit, an appearance image of an article included in a first shelf image obtained by capturing an image of a display shelf of the article and a position of an arrangement of the article indicated by the appearance image on the display shelf in association with each other; and detecting the appearance image stored in the storage unit from a second shelf image obtained by capturing an image of the display shelf after the first shelf image is obtained, and controlling a notification related to the arrangement of the article indicated by the appearance image based on a detection result.

A business support system according to an aspect of the present disclosure includes: a business support device that stores, in a storage unit, an appearance image of an article included in a first shelf image obtained by capturing an image of a display shelf of the article, and a position of an arrangement of the article indicated by the appearance image on the display shelf in association with each other, and configured to detect the appearance image stored in the storage unit from a second shelf image obtained by capturing an image of the display shelf after the first shelf image is obtained, and control a notification related to the arrangement of the article indicated by the appearance image based on a detection result thereof; and a terminal configured to display a content of the notification in response to reception of the notification.

These comprehensive or specific aspects may be implemented by a system, a device, a method, an integrated circuit, a computer program, or a recording medium, or may be implemented by any combination of the system, the device, the method, the integrated circuit, the computer program, and the recording medium.

### Advantageous Effects of Invention

According to the present disclosure, it is possible to improve the efficiency of a business when stockout occurs in a display shelf.

Further advantages and effects of an aspect of the present disclosure will become apparent from the specification and the drawings. These advantages and/or effects are provided by features described in several embodiments and the specification and drawings, and it is not necessary to provide all the features in the embodiments and the specification and drawings to obtain one or more identical features.

### BRIEF DESCRIPTION OF DRAWINGS

FIG. 1 is a diagram illustrating a configuration example of a business support system according to a first embodiment.

FIG. 2 is a diagram illustrating a configuration example of a stockout detection device according to the first embodiment.

FIG. 3 is a diagram illustrating an example of a surface of a display shelf on which commodities are displayed according to the first embodiment.

FIG. 4 is a diagram illustrating an example of shelf allocation information according to the first embodiment.

FIG. 5 is a diagram illustrating a configuration example of a terminal according to the first embodiment.

FIG. 6 is a diagram illustrating a configuration example of a business support device according to the first embodiment.

FIG. 7 is a diagram illustrating an example of management information according to the first embodiment.

FIG. 8 is a diagram illustrating an example of a login user interface (UI) for a business support service according to the first embodiment.

FIG. 9 is a diagram illustrating an example of a service menu UI in the business support service according to the first embodiment.

FIG. 10 is a diagram illustrating an example of a stockout information UI according to the first embodiment.

FIG. 11 is a diagram illustrating an example of a shelf map UI related to a stockout information service according to the first embodiment.

FIG. 12 is a diagram illustrating an example of a display shelf UI related to the stockout information service according to the first embodiment.

FIG. 13 is a diagram illustrating an example of the shelf map UI related to a shelf map service according to the first embodiment.

FIG. 14 is a diagram illustrating an example of the display shelf UI related to the shelf map service according to the first embodiment.

FIG. 15 is a diagram illustrating an example of an order history UI according to the first embodiment.

FIG. 16 is a diagram illustrating an example of the shelf map UI related to a shelf allocation advice service according to the first embodiment.

FIG. 17 is a diagram illustrating an example of a shelf allocation advice UI according to the first embodiment.

FIG. 18 is a diagram illustrating an example of a shelf allocation change UI according to the first embodiment.

FIG. 19 is a diagram illustrating an example of a price change UI according to the first embodiment.

FIG. 20 is a diagram for describing an example of a method of detecting a shelf label according to the first embodiment.

FIG. 21 is a diagram illustrating an example of a method of setting a section according to the first embodiment.

FIG. 22 is a diagram illustrating an example of a notification UI in a terminal according to a second embodiment.

FIG. 23 is a diagram illustrating an example of a map UI in the terminal according to the second embodiment.

FIG. 24 is a diagram illustrating an example of a notification list UI in the terminal according to the second embodiment.

FIG. 25 is a diagram illustrating an example of a notification detail UI in the terminal according to the second embodiment.

FIG. 26 is a diagram illustrating a modification of a display shelf according to the second embodiment.

FIG. 27 is a diagram for describing an example of processing of detecting an appearance image of a commodity from an image obtained by capturing an image of a display shelf according to a third embodiment.

FIG. 28 is a diagram for describing an example of processing of generating shelf allocation information based on a detection result of the appearance image of the commodity according to the third embodiment.

FIG. 29 is a diagram illustrating an example of shelf allocation information according to the third embodiment.

FIG. 30 is a diagram illustrating a display example of a shelf image in which stockout is detected according to the third embodiment.

FIG. 31 is a diagram illustrating a display example of a shelf image in which an erroneous arrangement is detected according to the third embodiment.

### DESCRIPTION OF EMBODIMENTS

Hereinafter, an embodiment of the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

### First Embodiment

<System Configuration>

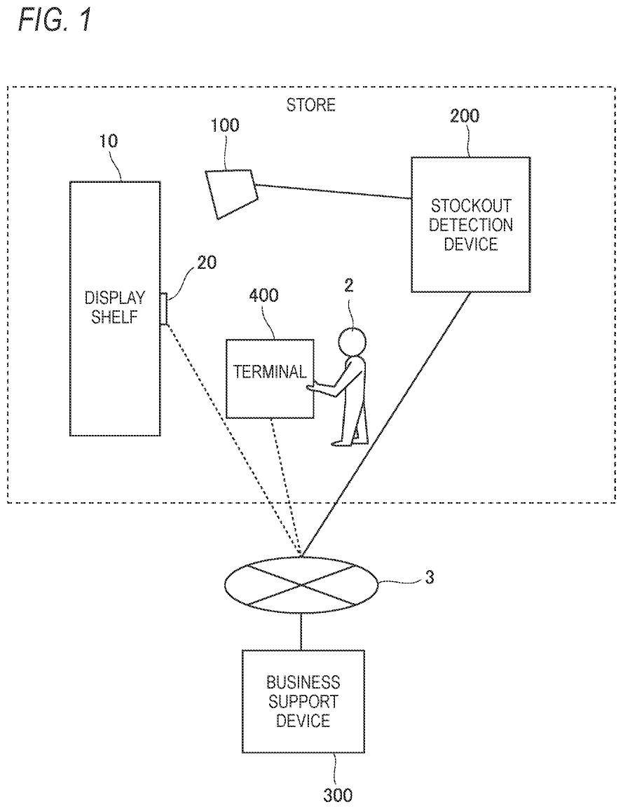

FIG. 1 is a diagram illustrating a configuration example of a business support system according to a first embodiment.

The business support system is a system that detects stockout of a commodity in a display shelf 10 arranged in a store and supports a business when the stockout is detected. The store is, for example, a supermarket, a convenience store, a department store, a mass retail store, a discount store, a bookstore, or a store of various facilities. On the display shelf 10, as an example of an article, commodities sold in the store are displayed. The display shelf 10 is not limited to being arranged in the store, and may be arranged outside the store.

In addition, a shelf label 20 for displaying a commodity name, a price, and the like of a displayed commodity may be attached to the display shelf 10. The shelf label 20 includes a liquid crystal display or an electronic paper, and is an electronic shelf label whose display content can be rewritten by wireless communication. However, the present embodiment is not limited to the electronic shelf label, and may be a shelf label whose display content is printed or handwritten on paper. The shelf label 20 may be read as another term such as a shelf tag, a shelf card, or a shelf label.

The business support system includes a camera device 100, a stockout detection device 200, and a business support device 300. The business support system may further include a terminal 400. The terminal 400 is possessed by, for example, a person (hereinafter, referred to as a “person in charge”) who performs a business on stockout. A person in charge 2 is, for example, a store clerk or a store manager of the store in which the display shelf 10 is arranged.

The camera device 100 is disposed at a position where the camera device 100 can capture an image of a surface of the display shelf 10 on which the commodities are displayed. The camera device 100 transmits the image obtained by capturing an image of the display shelf 10 (hereinafter, referred to as a “captured image”) to the stockout detection device 200 via a communication network. The communication network is implemented by, for example, a wired local area network (LAN) or a wireless LAN.

A plurality of camera devices 100 may be disposed in one store. In addition, one display shelf 10 may be captured by one camera device 100. Alternatively, a plurality of display shelves 10 may be captured by one camera device 100. Alternatively, one display shelf 10 may be captured by the plurality of camera devices 100. The camera device 100 may be a pan tilt zoom (PTZ) camera. The camera device 100 may be a device disposed for monitoring the inside of the store (that is, a monitoring camera). Alternatively, the camera device 100 may be disposed to detect stockout in the display shelf 10.

The stockout detection device 200 analyzes the captured image received from the camera device 100, and detects the display shelf 10 in which stockout occurs (hereinafter, referred to as a “stockout shelf”). When the stockout shelf is detected, the stockout detection device 200 transmits stockout detection information including at least identification information of the stockout shelf to the business support device 300 via a communication network 3. The communication network 3 is implemented by, for example, Internet. As illustrated in FIG. 1, the stockout detection device 200 is disposed in the store. Alternatively, the stockout detection device 200 may be disposed as a server (for example, a cloud server) that provides a predetermined service via the communication network 3. In this case, the camera device 100 may transmit the captured image to the stockout detection device 200 via the communication network 3. The stockout is not limited to a state in which a specific commodity is completely removed from the display shelf 10, and includes a state in which partial stockout is present. The state in which partial stockout is present may be a state in which the replenishment of commodities in the display shelf 10 is less than 100%, and may be, for example, a state in which the replenishment of commodities in the display shelf 10 is 50% or less or 30% or less. In addition, the partial stockout may be a state in which 20% to 80% of commodities are replenished in the display shelf 10, or a state in which a certain number of commodities (for example, 3 to 5 commodities in a shelf in which 10 commodities can be displayed at maximum) disappear. That is, the partial stockout may be a state in which the display shelf 10 is not at least full.

The business support device 300 receives the stockout detection information from the stockout detection device 200, and generates, based on the stockout detection information, information (hereinafter, referred to as “business support information”) for supporting the business related to the out-of-stock commodity of the person in charge 2. The business support device 300 transmits the generated business support information to the terminal 400 of the person in charge 2. The business support information is, for example, information for the terminal 400 to display a user interface (UI) for business support. In addition, the business support device 300 receives instruction information from the terminal 400 and performs processing corresponding to the instruction information. The instruction information is information indicating an instruction input to the terminal 400 by the person in charge 2. The business support device 300 is disposed as a server (for example, a cloud server) that provides the predetermined service via the communication network 3.

In addition, the business support device 300 may transmit, to the shelf label 20 of the store, information (hereinafter referred to as “shelf label update information”) for updating a display content of the shelf label 20 attached to the display shelf 10. The shelf label 20 that has received the shelf label update information updates the display content based on the shelf label update information. Examples of the display content on the shelf label 20 include a commodity name, a price, and/or POP information. The POP information is, for example, a catchphrase, an explanatory text, a discount price, or a discount rate.

The terminal 400 receives the business support information from the business support device 300, and displays the UI for the business support based on the business support information. In addition, the terminal 400 transmits the instruction information input by the person in charge 2 to the business support device 300. The terminal 400 is, for example, a tablet, a smartphone, or a PC. The UI displayed on the terminal 400 may be a UI generated by an application operating on the terminal 400 based on the business support information. Alternatively, the UI displayed on the terminal 400 may be a UI generated by a WEB browser operating on the terminal 400 based on the business support information.

<Configuration of Stockout Detection Device>

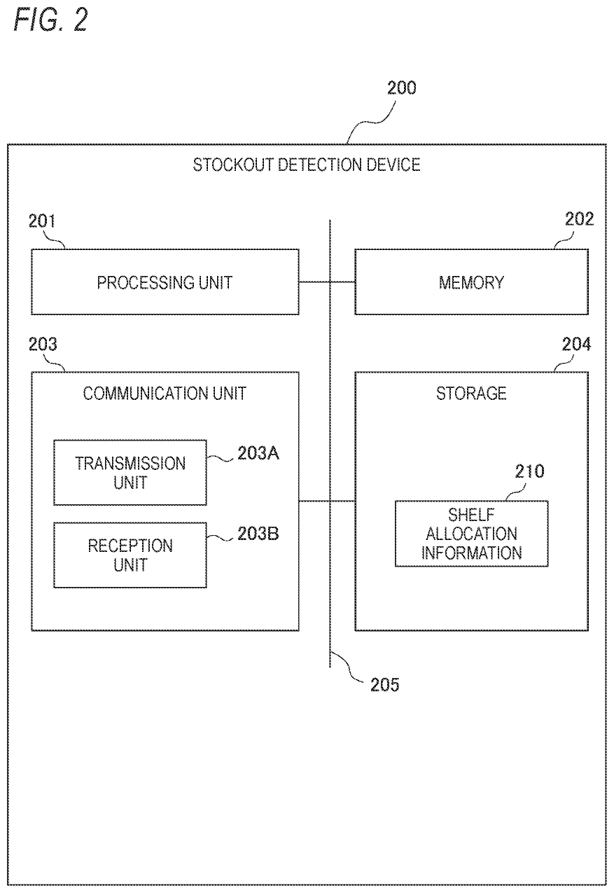

FIG. 2 is a diagram illustrating a configuration example of the stockout detection device 200. The stockout detection device 200 includes a processing unit 201, a memory 202, a communication unit 203, and a storage 204. These elements 201 to 204 are connected by an internal bus 205 capable of bidirectional communication. That is, the stockout detection device 200 may be implemented by a computer device including a processor and a memory.

The processing unit 201 executes a computer program and realizes functions of the stockout detection device 200. The processing unit 201 may be read as another term such as a processor, a controller, a central processing unit (CPU), or an integrated circuit. In addition, in the following description, the processing mainly performed by the stockout detection device 200 may be read as the processing mainly performed by the processing unit 201.

The memory 202 stores a computer program and data related to functions of the stockout detection device 200. The memory 202 may be implemented by, for example, a read only memory (ROM), a random access memory (RAM), or a combination thereof.

The storage 204 stores a computer program and data related to the functions of the stockout detection device 200. The storage 204 may be implemented by, for example, a hard disk drive (HDD), a solid state drive (SSD), or a flash memory. In addition, the storage 204 may store shelf allocation information 210. The shelf allocation information 210 is information used to identify the display shelf 10 and a section 30.

The communication unit 203 controls transmission and reception of data to and from other devices via the communication network. The communication unit 203 may include a transmission unit 203A that controls transmission of data and a reception unit 203B that controls reception of data. The communication unit 203 may be read as another term such as a communication interface or a communication module.

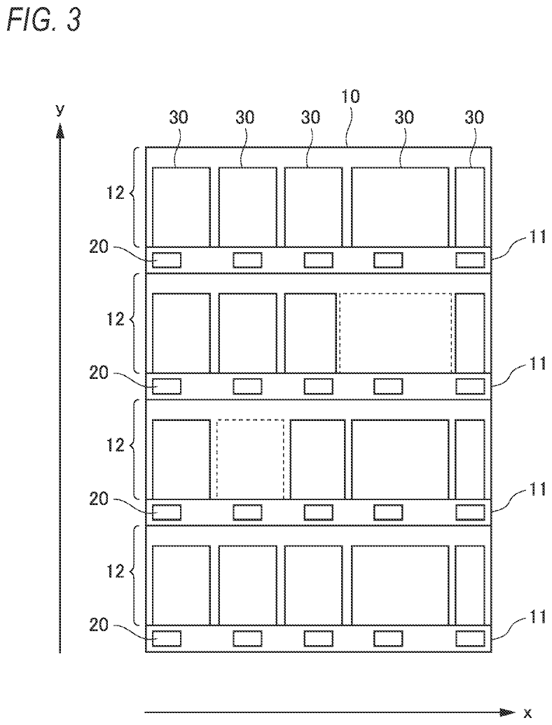

FIG. 3 is a diagram illustrating an example of a surface of the display shelf 10 on which commodities are displayed. Next, an example of a method in which the stockout detection device 200 detects the display shelf 10 in which stockout occurs will be described with reference to FIG. 3.

As illustrated in FIG. 3, the display shelf 10 is divided into a plurality of display spaces 12 by shelf plates 11. The shelf label 20 is attached to the shelf plate 11. The same commodity corresponding to the shelf label 20 is displayed in the space above the shelf label 20. In the present embodiment, the space in which the same commodity corresponding to the shelf label 20 is displayed is referred to as the section 30. The stockout detection device 200 sets the section 30 with respect to the captured image of the display shelf 10. In FIG. 3, a gap is provided between each of the sections 30, but the gap may not be provided. The shape of the section 30 is not limited to a rectangular shape, and may be a polygonal shape, an elliptical shape, or a circular shape. The section 30 may be manually set with respect to the captured image of the display shelf 10. Alternatively, the section 30 may be automatically set by the stockout detection device 200. An example in which the stockout detection device 200 automatically sets the section 30 will be described later.

In FIG. 3, the section 30 indicated by a dotted line indicates a section 30 in which stockout has occurred. The stockout detection device 200 analyzes the image of each section 30 in the captured image of the display shelf 10 as illustrated in FIG. 3, and determines whether stockout occurs in the display shelf 10.

For example, the stockout detection device 200 stores in advance an image (hereinafter, referred to as a “stockout image”) of the section 30 in a case where a commodity is not displayed (that is, in a case of stockout), and determines that stockout occurs in the display shelf 10 in a case where a stockout image is detected in the captured image of the display shelf 10. The stockout image is, for example, an image of a background of the display shelf 10.

In addition to the display shelf 10 in which stockout occurs (that is, a stockout shelf), the stockout detection device 200 may specify the section 30 in which the stockout occurs (hereinafter, referred to as a “stockout section”). In this case, the stockout detection device 200 may include identification information of a stockout shelf (hereinafter, referred to as “stockout shelf identification information”) and identification information of a stockout section (hereinafter, referred to as “stockout section identification information”) into the stockout detection information.

Further, the stockout detection device 200 may specify the commodity displayed in the stockout section (hereinafter, referred to as an “out-of-stock commodity”), and may include identification information of the specified out-of-stock commodity (hereinafter, referred to as “out-of-stock commodity identification information”) into the stockout detection information. The stockout detection device 200 may specify the out-of-stock commodity in the stockout section by using the shelf allocation information 210 to be described later.

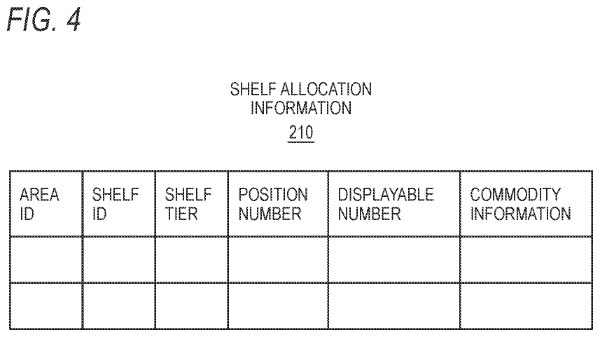

FIG. 4 is a diagram illustrating an example of the shelf allocation information 210.

As illustrated in FIG. 4, the shelf allocation information 210 includes, as items, an area ID, a shelf ID, a shelf tier, a position number, a displayable number, and commodity information.
The area ID is information for identifying an area in a store.
The shelf ID is information for identifying the display shelf 10 in the area indicated by the area ID.
The shelf tier is information indicating the number of tiers counted from the bottom in the display shelf 10 indicated by the shelf ID (that is, information indicating the display space 12). The shelf tier may be information indicating the number of tiers counted from the top.
The position number is information indicating a number of the section 30 counted from the left in the display space 12 indicated by the shelf tier. The position number may be information indicating a number of the section 30 counted from the right in the display space 12 indicated by the shelf tier.
The displayable number is information indicating the number of commodities that can be displayed in the section 30 indicated by the shelf tier and the position number.
The commodity information is information on commodities displayed in the section 30 indicated by the shelf tier and the position number. The commodity information includes, for example, at least one of a commodity code, a commodity name, and a price corresponding to the commodity.

The shelf tier and the position number in the shelf allocation information 210 are an example of information for identifying the section 30 in the display shelf 10 indicated by the shelf ID (hereinafter referred to as “section identification information”). As the information other than the shelf tier and the position number, coordinate values in the display shelf 10 are considered. The coordinate values are, for example, values that specify the position itself such as several mm to the right and several mm to the bottom from the upper left of the display shelf 10 as a starting point.

The stockout detection device 200 may specify the shelf ID of the display shelf 10 (that is, the stockout shelf) in which the stockout occurs with reference to the shelf allocation information 210, and may include the specified shelf ID into the stockout shelf identification information. In addition, the stockout detection device 200 may specify the section identification information and the displayable number of the sections 30 in which the stockout occurs with reference to the shelf allocation information 210, and may include the specified section identification information and the specified displayable number into the stockout section identification information. In addition, the stockout detection device 200 may specify the commodity information of the commodity in which the stockout occurs with reference to the shelf allocation information 210, and may include the specified commodity information into the out-of-stock commodity identification information.

<Configuration of Terminal>

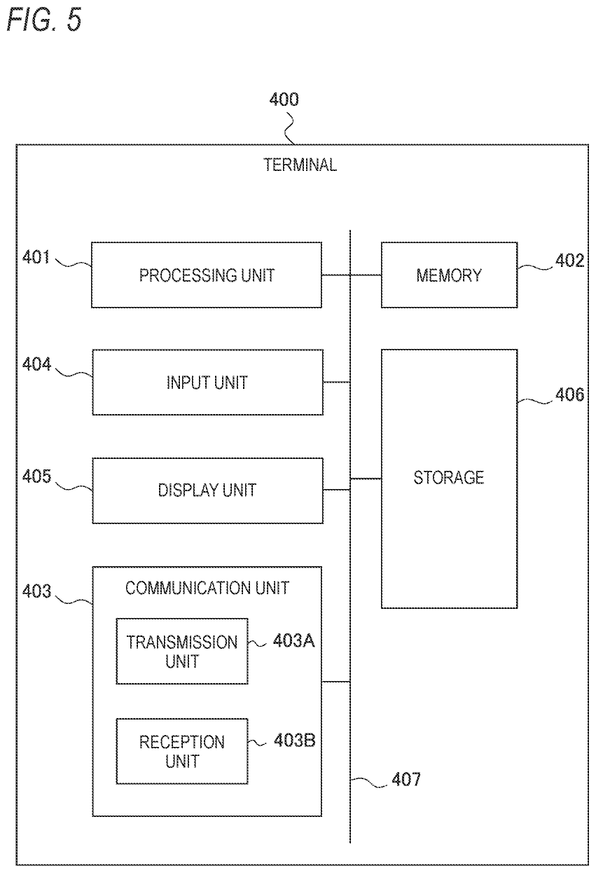

FIG. 5 is a diagram illustrating a configuration example of the terminal 400. The terminal 400 includes a processing unit 401, a memory 402, a communication unit 403, an input unit 404, a display unit 405, and a storage 406. These elements 401 to 406 are connected by an internal bus 407 capable of bidirectional communication. That is, the terminal 400 may be implemented by a computer device including a processor and a memory.

The processing unit 401 executes a computer program and realizes functions of the terminal 400. The processing unit 401 may be read as another term such as a processor, a controller, a CPU, or an integrated circuit. Further, in the following description, the processing mainly performed by the terminal 400 may be read as the processing mainly performed by the processing unit 401.

The memory 402 stores a computer program and data related to functions of the terminal 400. The memory 402 may be implemented by, for example, a ROM, a RAM, or a combination thereof.

The storage 406 stores a computer program and data related to the functions of the terminal 400. The storage 406 may be implemented by, for example, an HDD, an SSD, or a flash memory.

The communication unit 403 controls transmission and reception of data to and from other devices via the communication network. The communication unit 403 may include a transmission unit 403A that controls transmission of data and a reception unit 403B that controls reception of data. The communication unit 403 may be read as another term such as a communication interface or a communication module.

The input unit 404 receives an input of an operation to the terminal 400. The input unit 404 includes, for example, an input interface such as a button, a switch, a touch panel, and/or a microphone.

The display unit 405 displays characters, images, and the like of the UI. The display unit 405 may be read as another term such as a display or a monitor.

<Configuration of Business Support Device>

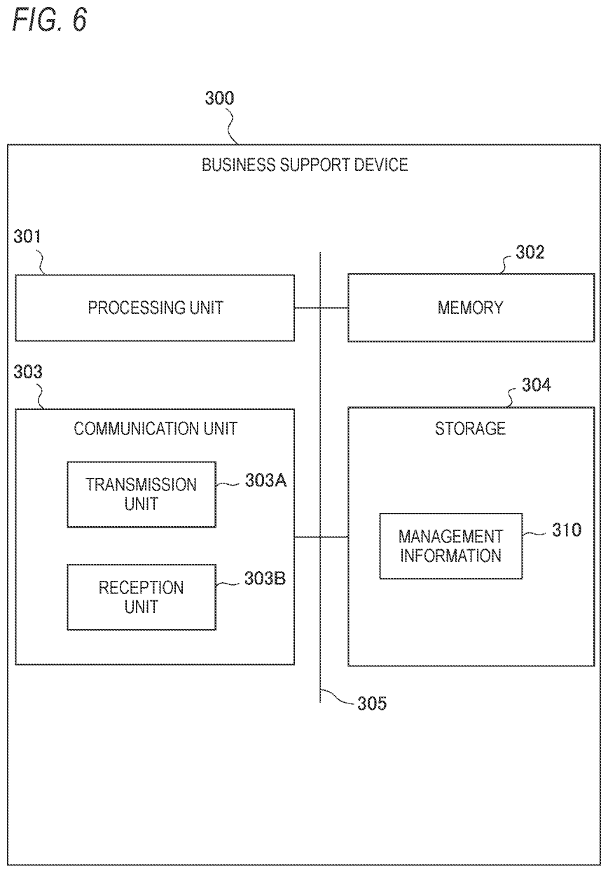

FIG. 6 is a diagram illustrating a configuration example of the business support device 300. The business support device 300 includes a processing unit 301, a memory 302, a communication unit 303, and a storage 304. These elements 301 to 304 are connected by an internal bus 305 capable of bidirectional communication. That is, the business support device 300 may be implemented by a computer device including a processor and a memory.

The processing unit 301 executes a computer program and realizes functions of the business support device 300. The processing unit 301 may be read as another term such as a processor, a controller, a CPU, or an integrated circuit. In the following description, the processing performed mainly by the business support device 300 may be read as the processing performed mainly by the processing unit 301.

The memory 302 stores a computer program and data related to the functions of the business support device 300. The memory 302 may be implemented by, for example, a ROM, a RAM, or a combination thereof.

The storage 304 stores a computer program and data related to the functions of the business support device 300. The storage 304 may be implemented by, for example, an HDD, an SSD, or a flash memory.

The communication unit 303 controls transmission and reception of data to and from other devices via the communication network. The communication unit 303 may include a transmission unit 303A that controls transmission of data and a reception unit 303B that controls reception of data. The communication unit 303 may be read as another term such as a communication interface or a communication module.

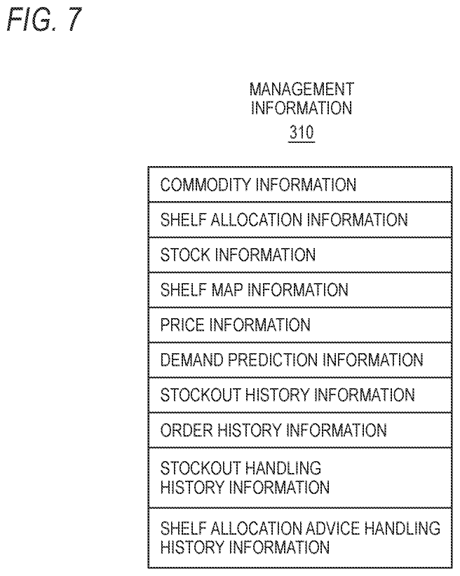

FIG. 7 is a diagram illustrating an example of management information. The business support device 300 stores management information 310 used for generating the business support information into the storage 304. The management information 310 includes at least one of the following information.
Commodity information which is information related to a commodity
Shelf allocation information which is information related to shelf allocation of a display shelf
Stock information which is information related to stock of a commodity
Shelf map information which is information related to an arrangement of a display shelf
Price information which is information related to a price of a commodity
Demand prediction information related to demand prediction of a commodity
Stockout history information which is history information related to stockout
Order history information which is history information related to an order
Stockout handling history information which is history information related to handling of stockout
Shelf allocation advice handling history information which is history information related to handling of an advice of shelf allocation

The shelf allocation information held by the business support device 300 may be the same information as the shelf allocation information 210 held by the stockout detection device 200 illustrated in FIG. 4. Alternatively, the shelf allocation information held by the business support device 300 may be information which is at least partially different from the shelf allocation information 210 held by the stockout detection device 200 illustrated in FIG. 4.

In addition, the business support device 300 may hold the shelf allocation information for each store.

Next, a business support service provided to the terminal 400 of each store by the business support device 300 will be described.

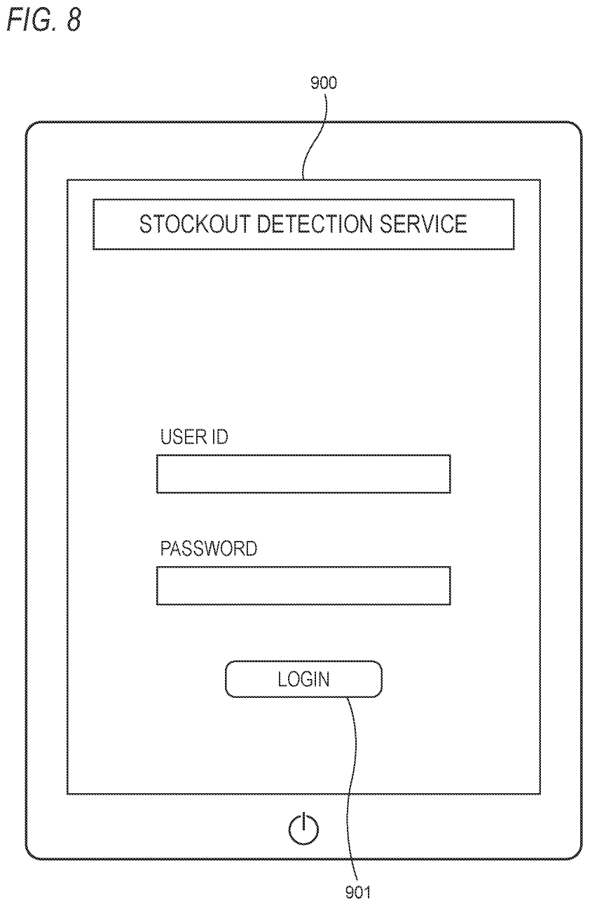

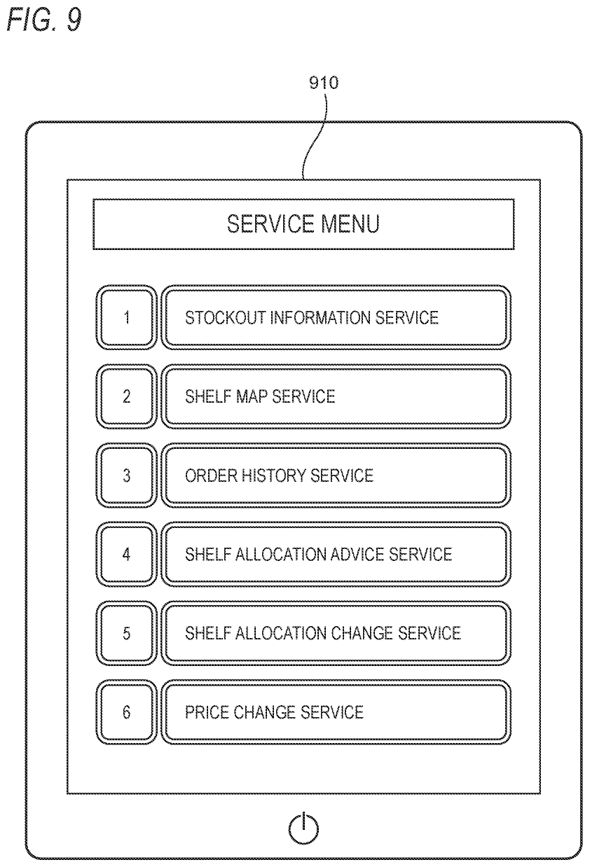

FIG. 8 is a diagram illustrating an example of a login UI for the business support service. FIG. 9 is a diagram illustrating an example of a service menu UI in the business support service.

When the business support device 300 receives access from the terminal 400, the business support device 300 first provides a login UI 900 illustrated in FIG. 8 to the terminal 400. The person in charge 2 inputs a user ID and a password given to the person in charge 2 in advance to the login UI 900, and presses a login button 901. When the authentication of the input user ID and password is successful, the business support device 300 provides a service menu UI 910 illustrated in FIG. 9 to the terminal 400. The term “press” of a button in the description of the UI can be read as another term such as “touch”, “tap”, “click”, or “select” of the button.

As illustrated in FIG. 9, the business support device 300 provides the following business support service.
A stockout information service for providing information related to stockout
A shelf map service for providing position information of a display shelf
An order history service for providing order history information of a commodity
A shelf allocation advice service for providing advice information related to shelf allocation
A shelf allocation change service for receiving a change in shelf allocation
A price change service for receiving a change in price of a commodity

Next, each of the above-described business support services will be described.

<Stockout Information Service>

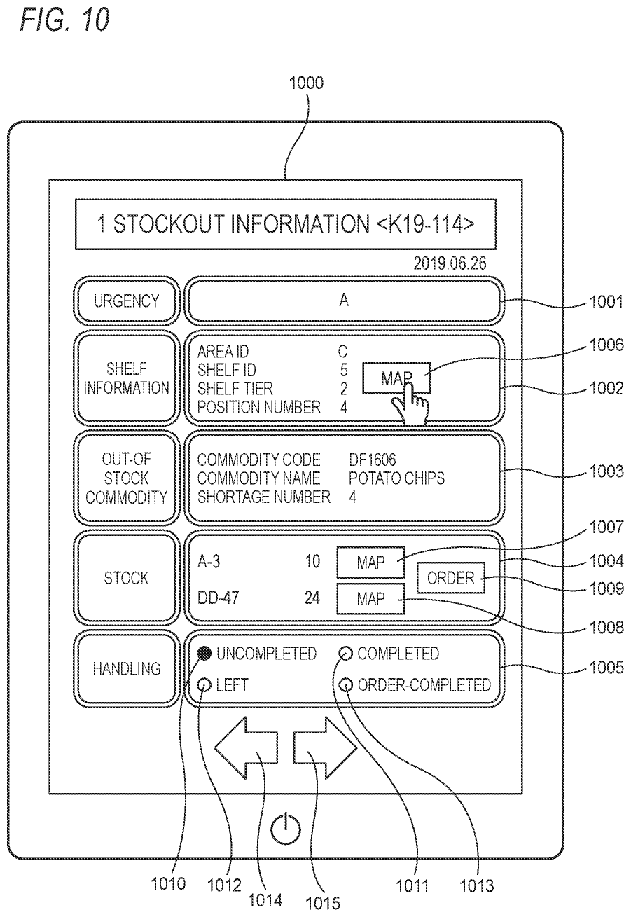

FIG. 10 is a diagram illustrating an example of a stockout information UI. When the stockout information service is selected from the service menu UI 910, the business support device 300 provides a stockout information UI 1000 as illustrated in FIG. 10 to the terminal 400.

The stockout information UI 1000 includes an urgency region 1001, a stockout shelf information region 1002, an out-of-stock commodity information region 1003, a stock information region 1004, and a handling region 1005.

In the urgency region 1001, information indicating the degree of urgency of replenishment of an out-of-stock commodity (hereinafter, referred to as “urgency information”) is displayed. The urgency information may be values of A, B, and C in descending order of urgency. The business support device 300 may determine the urgency information according to the shelf stock quantity of the out-of-stock commodity, the demand information of the out-of-stock commodity, and the like. For example, the business support device 300 determines the urgency to be A in a case where the shelf stock quantity of the out-of-stock commodity is less than a₁, determines the urgency to be B in a case where the shelf stock quantity of the out-of-stock commodity is less than a₂, and determines the urgency to be C in a case where the shelf stock quantity of the out-of-stock commodity is less than a₃. a₁, a₂, and a₃ are integers of 1 or more, and a₁<a₂<a₃. The person in charge 2 can appropriately determine the urgency of replenishment of the out-of-stock commodity by referring to the urgency information. In addition, it is preferable to predict that the demand will increase and decrease by marketing such as reselling, and increase the urgency before the demand is predicted to increase. That is, even though the number of commodities arranged on the shelf is not reduced, replenishment of commodities may be instructed by demand prediction and the like, and the urgency may be set to be high (A, B, and the like).

In the stockout shelf information region 1002, as information for specifying a stockout shelf and a stockout section, for example, as illustrated in FIG. 10, information related to the area ID, the shelf ID, the shelf tier and the position number, or the coordinates is displayed. The business support device 300 may specify these pieces of information based on the stockout detection information received from the stockout detection device 200.

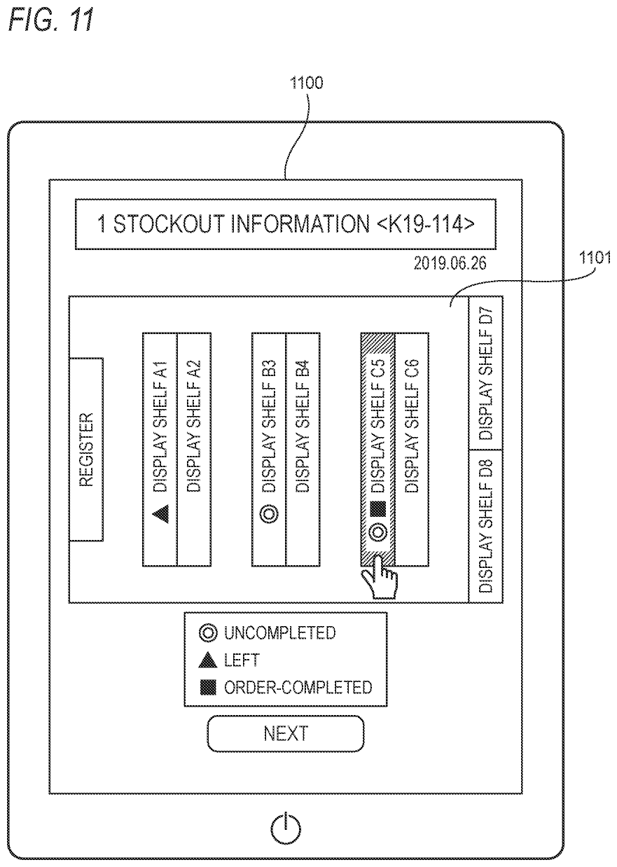

In addition, a button 1006 for displaying the position of the stockout shelf on a map is displayed in the stockout shelf information region 1002. When the button 1006 is pressed, the business support device 300 provides a shelf map UI 1100 as illustrated in FIG. 11 to the terminal 400. The shelf map UI 1100 will be described later (see FIG. 11).

In the out-of-stock commodity information region 1003, the commodity information and the shortage number of the out-of-stock commodity are displayed. The commodity information includes the commodity code and the commodity name. For example, the business support device 300 specifies the commodity information and the shortage number of the out-of-stock commodity from the stockout detection information received from the stockout detection device 200 or the demand prediction information of the commodity. The shortage number may be specified based on the displayable number included in the stockout detection information, or may be changed to increase the shortage number before the demand is predicted to increase by predicting that the demand will increase and decrease by marketing such as reselling That is, even though the number of commodities arranged on the shelf is not reduced, replenishment of commodities may be instructed by demand prediction and the like, or the shortage number thereof may be set to increase. In this case, the shelf allocation may be changed due to an increase in the shelf stock. In addition, the shortage number does not necessarily have to be an absolute number of commodities, and may be classified into A (1 to 10), B (11 to 20), C (21 to 30), and the like as the shortage degree.

The stock information of the out-of-stock commodity is displayed in the stock information region 1004. As illustrated in FIG. 10, the stock information may include a first stock position and a stock quantity of the out-of-stock commodity, and a second stock position and a stock quantity of the out-of-stock commodity. For example, the first stock position is a position of a stock shelf present in the same area as the display shelf 10, and the second stock position is a position of a stock shelf present in an area (for example, a backyard of a store) different from the display shelf 10. The example of FIG. 10 indicates that “10” out-of-stock commodities are present at the first stock position “A-3” and “24” out-of-stock commodities are present at the second stock position “DD-47”. For example, based on the stock information of the store, the business support device 300 specifies the stock position and the stock number of the out-of-stock commodity.

In addition, in the stock information region 1004, as illustrated in FIG. 10, a button 1007 for displaying the first stock position on a map and a button 1008 for displaying the second stock position on a map are displayed. When the buttons 1007 and 1008 are pressed, the business support device 300 provides a stock position map UI to the terminal 400. Although the stock position map UI is not illustrated, the stock position map UI may be the same as the shelf map UI 1100 illustrated in FIG. 11.

In addition, in the stock information region 1004, a button 1009 for ordering an out-of-stock commodity is displayed. When the button 1009 is pressed, the business support device 300 provides a UI (not illustrated) for ordering an out-of-stock commodity to the terminal 400.

In the handling region 1005, a button for selecting a handling for the out-of-stock commodity is displayed. For example, as illustrated in FIG. 10, an uncompleted button 1010, a completed button 1011, a left button 1012, and an order-completed button 1013 are displayed in the handling region 1005. When the handling to the out-of-stock commodity is not completed, the person in charge 2 may select the uncompleted button 1010. When the handling to the out-of-stock commodity has been completed, the person in charge 2 may select the completed button 1011. When the person in charge 2 leaves the handling to the out-of-stock commodity, the person in charge 2 may select the left button 1012. When the order of the out-of-stock commodity has been completed, the person in charge 2 may select the order-completed button 1013. The business support device 300 records the information of the handling corresponding to the selected button as the stockout handling history information.

In the stockout information UI 1000, a stockout occurrence ID for identifying occurrence of stockout may be displayed. “K19-114” illustrated in FIG. 10 is a display example of the stockout occurrence ID.

In addition, in FIG. 10, a left arrow button 1014 and a right arrow button 1015 are buttons for switching the display to the stockout information UI 1000 corresponding to another stockout occurrence ID. For example, when the left arrow button 1014 is pressed, the business support device 300 provides the stockout information UI corresponding to the previous stockout occurrence ID to the terminal 400, and when the right arrow button 1015 is pressed, the business support device 300 provides the stockout information UI corresponding to the next stockout occurrence ID to the terminal 400.

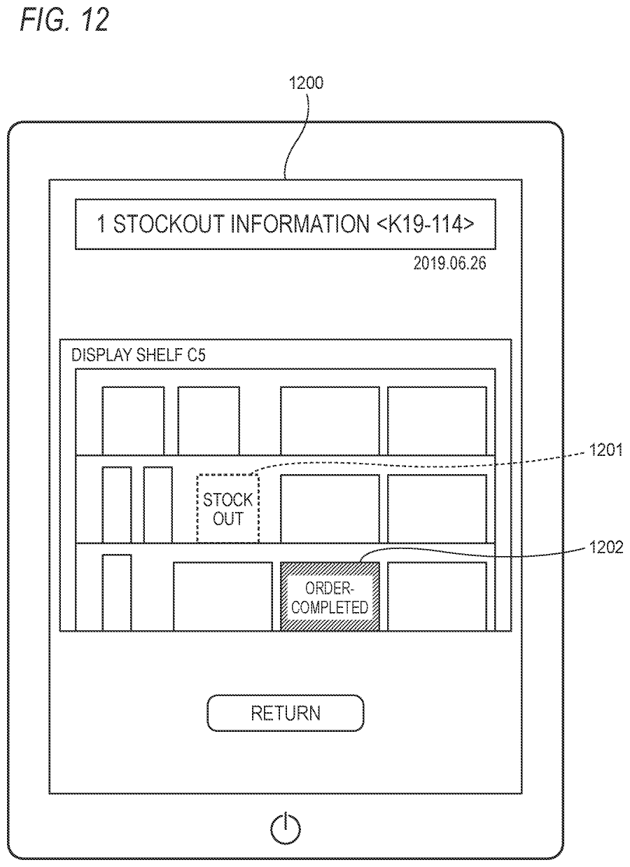

FIG. 11 is a diagram illustrating an example of a shelf map UI related to the stockout information service. FIG. 12 is a diagram illustrating an example of a display shelf UI related to the stockout information service. When the button 1006 in the stockout shelf information region 1002 of the stockout information UI 1000 is pressed, the business support device 300 provides the shelf map UI 1100 as illustrated in FIG. 11 to the terminal 400.

On the shelf map UI 1100, an image indicating the stockout shelf is displayed together with a shelf map indicating the arrangement of the display shelf 10 of the store. For example, the stockout shelf is displayed in a form (for example, in a different color) distinguishable from another display shelf 10.

In addition, on the shelf map UI 1100, information indicating a situation of handling to the stockout in the display shelf 10 is displayed. For example, as illustrated in FIG. 11, a double circle mark may be displayed on the display shelf 10 in which the handling to the stockout is “uncompleted”, a black triangle mark may be displayed on the display shelf 10 in which the handling to the stockout is “left”, and a black square mark may be displayed on the display shelf 10 in which the handling to the stockout is “order-completed”. The display of the marks illustrated in FIG. 11 is an example, and a mark different from these marks may be displayed.

When the person in charge 2 selects a stockout shelf from the shelf map UI 1100, the business support device 300 provides a display shelf UI 1200 corresponding to the selected stockout shelf to the terminal 400. As illustrated in FIG. 12, the display shelf UI 1200 schematically illustrates the display shelf 10. Alternatively, the display shelf UI 1200 may use an image of the display shelf 10 captured by the camera device 100.

In the display shelf UI 1200, a stockout section 1201 may be displayed in a form (for example, in a different color) different from that of another section 30. In addition, in the display shelf UI 1200, an order-completed stockout section 1202 may be displayed in a form (for example, in a different color) different from that of another section 30.

By using the stockout information service, the person in charge 2 can efficiently check the information related to the stockout. When the stockout detection information is received from the stockout detection device 200, the business support device 300 may present the stockout information UI 1000 to the terminal 400 by a push notification. Accordingly, when stockout occurs, the person in charge 2 can immediately recognize the out-of-stock commodity and the stockout shelf, and thus can quickly handle the stockout.

<Shelf Map Service>

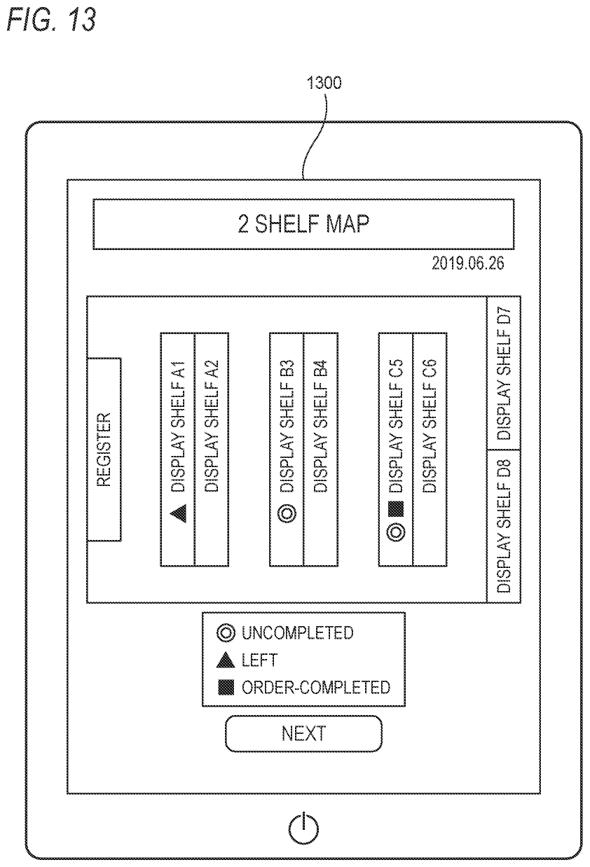

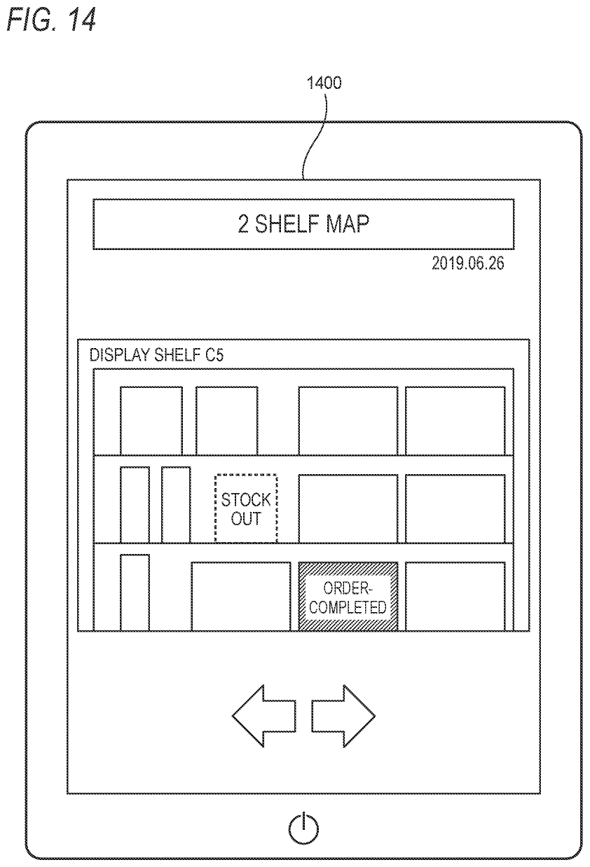

FIG. 13 is a diagram illustrating an example of a shelf map UI related to the shelf map service. FIG. 14 is a diagram illustrating an example of a display shelf UI related to the shelf map service. When a shelf map service is selected from the service menu UI 910, the business support device 300 provides a shelf map UI 1300 as illustrated in FIG. 13 to the terminal 400.

When there is a stockout shelf in the shelf map UI 1300, the stockout shelf may be displayed in a form (for example, in a different color) different from that of the display shelf 10 in which no stockout occurs. Since the shelf map UI 1300 is substantially the same as the shelf map UI 1100 described with reference to FIG. 11, a detailed description thereof will be omitted.

When the person in charge 2 selects a display shelf 10 from the shelf map UI 1300, the business support device 300 provides a display shelf UI 1400 corresponding to the selected display shelf 10 to the terminal 400 as illustrated in FIG. 14.

When there is a stockout section in the display shelf UI 1400, similar to FIG. 12, the stockout section may be displayed in a form (for example, in a different color) different from another section 30. In addition, when there is an order-completed stockout section in the display shelf UI 1400, similar to FIG. 12, the order-completed stockout section may be displayed in a form (for example, in a different color) different from that of another section 30. Since the display shelf UI 1400 is substantially the same as the display shelf UI 1200 described with reference to FIG. 12, a detailed description thereof will be omitted.

The person in charge 2 can visually check the stockout shelf from the shelf map by using the shelf map service.

<Order History Service>

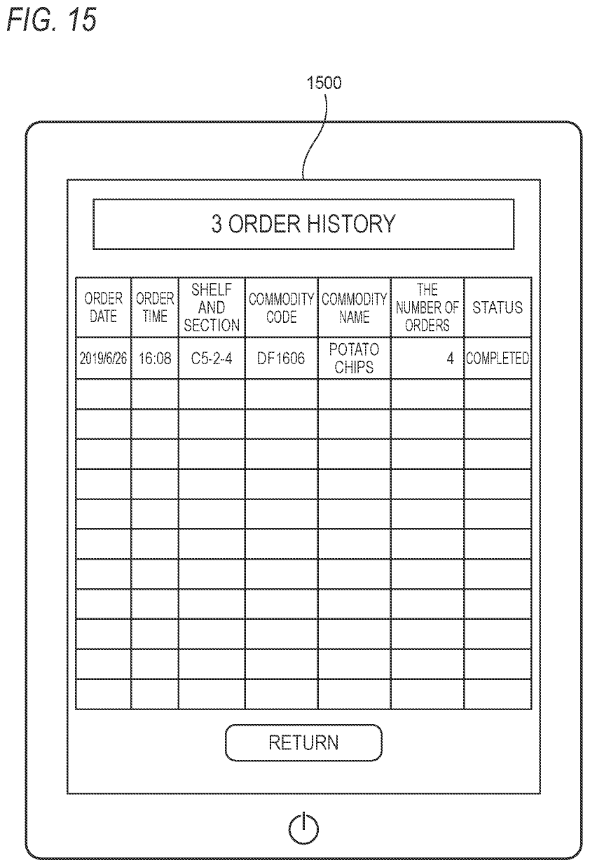

FIG. 15 is a diagram illustrating an example of an order history UI. When an order history service is selected from the service menu UI 910, the business support device 300 provides an order history UI 1500 as illustrated in FIG. 15 to the terminal 400.

The order history UI 1500 displays an order date, an order time, identification information of a stockout shelf and an stockout section, a commodity code, a commodity name, the number of orders, and a status related to the order for each ordered commodity. The business support device 300 may generate the order history UI 1500 based on the order history information.

The person in charge 2 can easily check the history information of the order for the stockout by using the order history service.

<Shelf Allocation Advice Service>

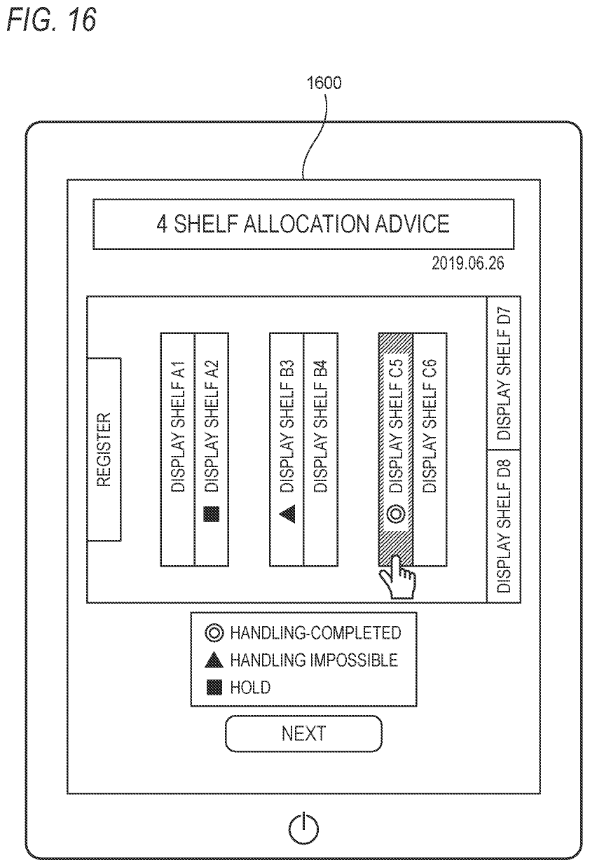

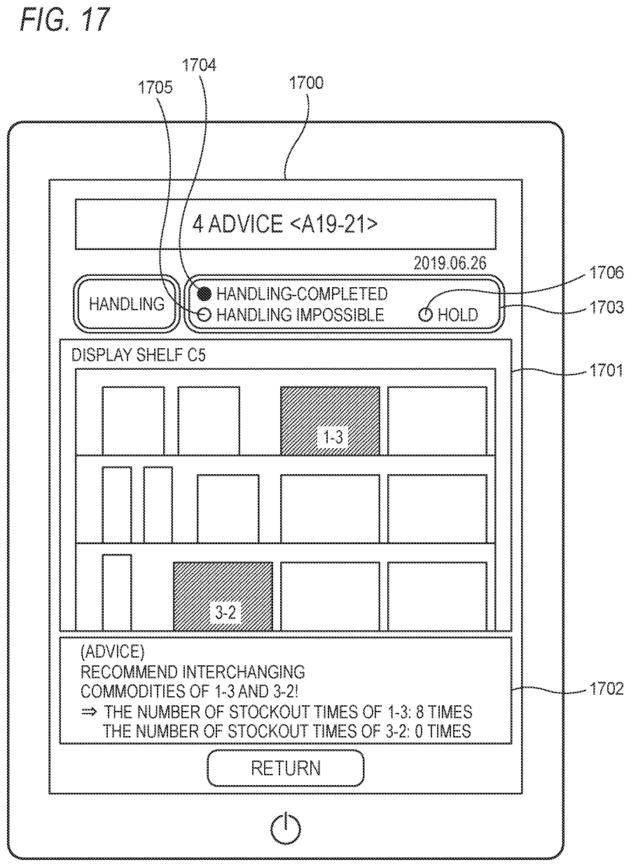

FIG. 16 is a diagram illustrating an example of a shelf map UI related to the shelf allocation advice service. FIG. 17 is a diagram illustrating an example of a shelf allocation advice UI. When a shelf allocation advice service is selected from the service menu UI 910, the business support device 300 provides a shelf map UI 1600 as illustrated in FIG. 16 to the terminal 400. Since the shelf map UI 1600 is substantially the same as the shelf map UI 1100 described with reference to FIG. 11, a detailed description thereof will be omitted.

When the person in charge 2 selects a display shelf 10 to receive an advice of the shelf allocation from the shelf map UI 1600, the business support device 300 provides a shelf allocation advice UI 1700 corresponding to the selected display shelf 10 to the terminal 400 as illustrated in FIG. 17.

The shelf allocation advice UI 1700 includes a display shelf region 1701, an advice region 1702, and a handling region 1703.

In the display shelf region 1701, the current shelf allocation in the selected display shelf and information specifying the section 30 which is an advice target are displayed.

In the advice region 1702, the content of the advice for the section 30 which is the advice target is displayed. For example, in the advice region 1702, as illustrated in FIG. 17, a sentence that recommends interchanging commodities of a section “1-3” and a section “3-2” which are advice targets is displayed. In addition, the reason for the advice may be displayed in the advice region 1702. For example, as illustrated in FIG. 17, in the advice region 1702, a sentence indicating that the number of stockout times of the section “1-3” is “8 times” and the number of stockout times of the section “3-2” is “0 times” is displayed.

A button for selecting a handling to the advice is displayed in the handling region 1703. For example, as illustrated in FIG. 17, a handling-completed button 1704, a handling impossible button 1705, and a hold button 1706 are displayed in the handling region 1703. When the handling to the advice has been completed, the person in charge 2 may select the handling-completed button 1704. When it is not possible to handle the advice, the person in charge 2 may select the handling impossible button 1705. When the handling to the advice is held, the person in charge 2 may select the hold button 1706. The business support device 300 records the information of the handling corresponding to the selected button as the shelf allocation advice handling history information.

The business support device 300 may generate the advice of the shelf allocation based on the shelf allocation information and the stockout history information. For example, the business support device 300 may generate an advice for interchanging a section 30 of a commodity in which the number of times of occurrence of stockout is b₁ times or more and a section 30 of a commodity in which the number of times of occurrence of stockout is less than b₂ times. b₁ and b₂ are integers of 1 or more, and b₁>b₂. This is because it is considered that the commodity in which the stockout frequently occurs is a popular commodity and is sufficiently sold even when the section 30 (that is, the shelf allocation) to be displayed is changed, and it is considered that the commodity in which the stockout hardly occurs is not sufficiently recognized and there is room for increasing the sales number by changing the section 30 (that is, the shelf allocation) to be displayed.

The advice ID for identifying an advice may be displayed on the shelf allocation advice UI 1700. “A19-21” illustrated in FIG. 17 is a display example of the advice ID.

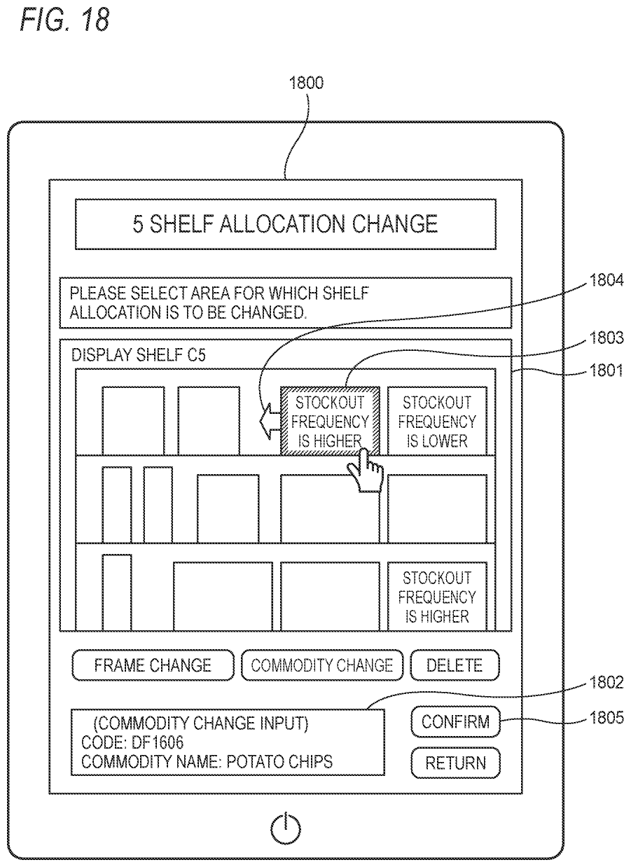

In addition, the shelf allocation advice UI 1700 may display a button (not illustrated) for transitioning to a shelf allocation UI (see FIG. 18) for changing the shelf allocation of the display shelf 10 being displayed.

By using the shelf allocation advice service, the person in charge 2 can know the shelf allocation in which the sales performance can be improved.

<Shelf Allocation Change Service>

FIG. 18 is a diagram illustrating an example of a shelf allocation change UI.

When a shelf allocation change service is selected from the service menu UI 910, the business support device 300 provides a shelf allocation changing UI 1800 illustrated in FIG. 18 to the terminal 400.

The shelf allocation change UI 1800 includes a shelf region 1801 and a commodity input region 1802.

In the shelf region 1801, the sections 30 of the current shelf allocation are displayed. The person in charge 2 can operate the section 30 in the shelf region 1801 to enlarge and reduce the section 30, replace the section 30, and the like. For example, the person in charge 2 can select a section 1803, and can enlarge the section 1803 by sliding the left side of the section 1803 in a direction of an arrow 1804.

The commodity information of a commodity displayed in the section 30 is input into the commodity input region 1802. When the person in charge 2 selects the section 30 of the shelf region 1801 and inputs the commodity information of the commodity displayed in the section 30 into the commodity input region 1802, the business support device 300 updates the shelf allocation information such that the commodity information input to the commodity input region 1802 is associated with the selected section 30. The person in charge 2 may manually input the commodity information into the commodity input region 1802. Alternatively, the person in charge 2 may input the commodity information into the commodity input region 1802 by reading a barcode (or a QR code (registered trademark)) attached to the commodity using a camera of the terminal 400.

When a confirm button 1805 is pressed, the business support device 300 updates the shelf allocation information based on the changed section 30 and/or the commodity information.

In the shelf region 1801, the section 30 of the recommended shelf allocation may be displayed instead of the section 30 of the current shelf allocation. For example, based on the shelf allocation information and the stockout history information, the business support device 300 determines the section 30 of the recommended shelf allocation by the same method as the advice of the shelf allocation described above.

The person in charge 2 can easily notify the business support device 300 of the change of the shelf allocation by using the shelf allocation change service.

<Price Change Service>

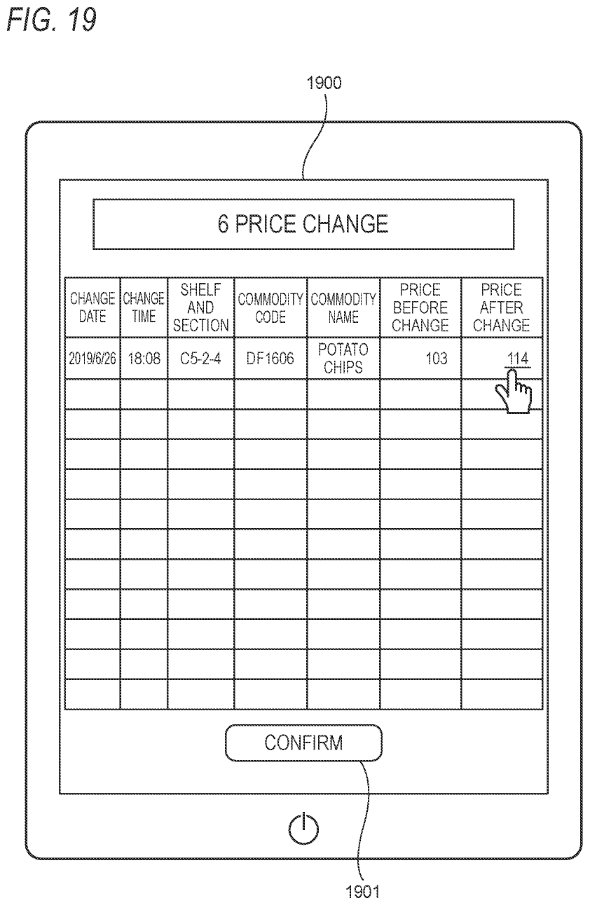

FIG. 19 is a diagram illustrating an example of a price change UI. When a price change service is selected from the service menu UI 910, the business support device 300 provides a price change UI 1900 illustrated in FIG. 19 to the terminal 400.

The price change UI 1900 displays a price change date, a price change time, identification information of the display shelf 10 and the section 30 on which the commodity is displayed, a commodity code, a commodity name, a price before change, and a price after change for each commodity whose price is changed.

The price after change may be determined by the business support device 300.

In addition, the person in charge 2 may select the price after change from the price change UI 1900 and rechange the price after change determined by the business support device 300.

When the confirm button 1805 is pressed, the business support device 300 stores the price after change in the price information. In addition, when the confirm button 1805 is pressed, the business support device 300 updates a display price of the shelf label 20 to the price after change. The business support device 300 may change the price of the commodity in accordance with the change of the section 30.

The person in charge 2 can efficiently change the display price of the shelf label 20 on the display shelf 10 by using the price change service.

<Modification of Business Support Service>

The business support device 300 may provide information indicating the degree of stockout of each commodity in a store and/or an area designated by the person in charge 2 to the terminal 400. The business support device 300 may provide information indicating the degree of stockout of each commodity in all stores to the terminal 400.

<Method of Automatically Setting Section of Display Shelf>

Next, an example of a method of automatically setting the section 30 in the stockout detection device 200 will be described.

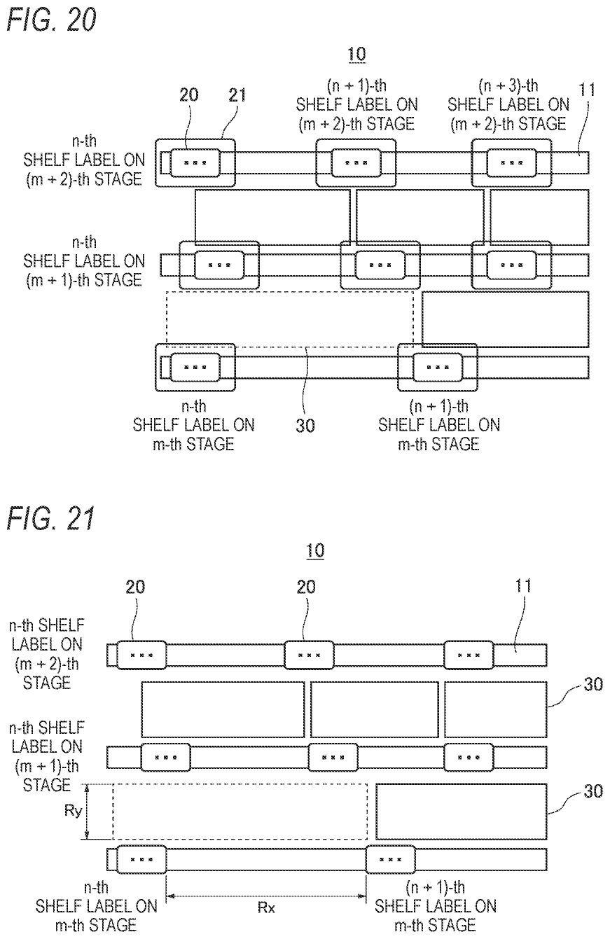

FIG. 20 is a diagram for describing an example of a method of detecting the shelf label 20.

For example, the stockout detection device 200 analyzes the captured image of the display shelf 10 illustrated in FIG. 20, and detects the n-th shelf label 20 from the left and the (n+1)-th shelf label 20 from the left, which are attached to the m-th shelf plate 11 from the bottom. Similarly, the stockout detection device 200 detects the n-th shelf label 20 from the left, the (n+1)-th shelf label 20 from the left, and the (n+2)-th shelf label 20 from the left, which are attached to the (m+1)-th shelf plate 11 from the bottom. Similarly, the stockout detection device 200 detects the n-th shelf label 20 from the left, the (n+1)-th shelf label 20 from the left, and the (n+2)-th shelf label 20 from the left, which are attached to the (m+2)-th shelf plate 11 from the bottom. m and n are each an integer of 1 or more. Accordingly, the stockout detection device 200 may detect the shelf labels 20 from left to right for each shelf tier. The detection from left to right is an example, and the stockout detection device 200 may detect the shelf labels 20 from right to left.

FIG. 21 is a diagram for describing an example of a method of setting the section 30.

The stockout detection device 200 sets the section 30 corresponding to the shelf label 20 based on a position of the shelf label 20 detected as described above. For example, when the n-th shelf label 20 on the m-th stage corresponding to the commodity is attached to the lower left of the section 30 in which the common commodity is displayed, the stockout detection device 200 performs the following processing. That is, the stockout detection device 200 sets a width Rx from a position of the n-th shelf label 20 on the m-th stage to a position of the (n+1)-th shelf label 20 on the m-th stage (that is, the right adjacent the shelf label 20) as a width of the section 30, and sets a height Ry from the position of the n-th shelf label 20 on the m-th stage to a position of the n-th shelf label 20 on the (m+1)-th stage (that is, the upper stage) as a height of the section 30. Then, the stockout detection device 200 associates the section 30 set in this manner with the n-th shelf label 20 on the m-th stage.

Accordingly, the stockout detection device 200 can automatically set the section 30 corresponding to the n-th shelf label 20 on the m-th stage.

The method of automatically setting the section 30 of the display shelf 10 is not limited to the above-described method. For example, the stockout detection device 200 may associate the section 30 below the shelf label 20 with the shelf label 20. The stockout detection device 200 may set the predetermined width Rx around the shelf label 20 as the width of the section 30. The stockout detection device 200 may set, as the section 30, each of the display spaces 12 divided at equal intervals. The stockout detection device 200 may set the section 30 based on partition plates physically present in the display spaces 12. In addition, before the commodity is displayed, the business support device 300 may determine the section 30 of the display shelf 10 including the commodity to be displayed, and provide the section 30 to the terminal 400. In a case where it is desired to change the section 30 and the like due to the circumstances on the store side, an instruction may be given by the shelf allocation change UI 1800 illustrated in FIG. 18 described above.

### Modification

The function of the stockout detection device 200 may be included in the business support device 300. In this case, the business support device 300 may receive a captured image from the camera device 100 via the communication network 3, and may execute a setting of the section 30 in the display shelf 10, generation of the shelf allocation information 210, detection of stockout, and the like, similarly to the stockout detection device 200 described above.

### Summary of First Embodiment

The business support device (300) according to the first embodiment includes: the reception unit (303B) configured to receive, from the stockout detection device (200) for detecting a stockout shelf which is a display shelf in which stockout has occurred based on a captured image of the display shelf (10) of an article, information related to the stockout shelf; the processing unit (301) configured to specify a position of the stockout shelf based on the information related to the stockout shelf and shelf map information indicating an arrangement of the display shelf, and generate business support information including information indicating the position of the stockout shelf; and the transmission unit (303A) configured to transmit the business support information to the terminal (400). Accordingly, the terminal can display the information indicating the position of the stockout shelf. Therefore, since the person in charge can recognize the position of the stockout shelf through the terminal, it is possible to improve the efficiency of the business related to the stockout.

The processing unit (301) may include, in the business support information, information for the terminal (400) to display the stockout shelf in a form different from that of another display shelf (10). Accordingly, the terminal can display the stockout shelf in a form different from that of another display shelf. Therefore, since the person in charge can visually recognize the stockout shelf through the terminal, it is possible to improve the efficiency of the business related to the stockout.

The reception unit (303B) may receive information, which is input to the terminal (400) and indicates the handling to the stockout shelf, and the processing unit (301) may include, in the business support information, the information indicating the handling to the stockout shelf. Accordingly, the terminal (400) can display the information indicating the handling to the stockout for the stockout shelf. Therefore, since the person in charge can recognize the handling to the stockout at the present time for the stockout shelf through the terminal, it is possible to improve the efficiency of the business related to the stockout.

The processing unit (301) may include, in the business support information, information related to an article in which stockout has occurred and information related to stock of the article in which the stockout has occurred. Accordingly, the terminal can display the information related to the article in which the stockout has occurred and the information related to the stock of the article in which the stockout has occurred. Therefore, since the person in charge can recognize, through the terminal, the information related to the article in which the stockout has occurred and the information related to the stock of the article in which the stockout has occurred, it is possible to improve the efficiency of the business for the stockout.

The processing unit (301) may determine, based on information indicating a situation of the stock of the article in which the stockout has occurred, urgency of replenishment of the article in which the stockout has occurred, and may include information indicating the urgency into the business support information. Accordingly, the terminal can display the urgency of the replenishment of the article in which the stockout has occurred. Therefore, since the person in charge can recognize, through the terminal, the urgency of the replenishment of the article in which the stockout has occurred, it is possible to improve the efficiency of the business related to the stockout.

The information related to the stockout shelf may include identification information of a stockout section which is the section (30) in which the stockout has occurred in the stockout shelf, which is detected by the stockout detection device (200). The processing unit (301) may include, in the business support information, information for the terminal (400) to display the stockout section in a form different from that of another section (30). Accordingly, the terminal can display the stockout section in a form different from another section. Therefore, since the person in charge can visually recognize the stockout section through the terminal, it is possible to improve the efficiency of the business related to the stockout.

The processing unit (301) may generate information related to a change of the section based on the history information related to the stockout in the section (30), and may include the information into the business support information. Accordingly, the terminal can display the information (for example, advice information of shelf allocation) related to the change of the section of the display shelf. Therefore, since the person in charge can recognize, through the terminal, the change to a more appropriate section of the display shelf, it is possible to improve the efficiency of the business related to the shelf allocation.

### Second Embodiment

In a second embodiment, another UI related to a stockout notification in the terminal 400 will be described. In the second embodiment, the same reference numerals are given to the contents described in the first embodiment, and the description thereof may be omitted. In addition, in the following description, the processing mainly described by the terminal 400 may be processing executed by the processing unit 401 of the terminal 400.

<Notification UI>

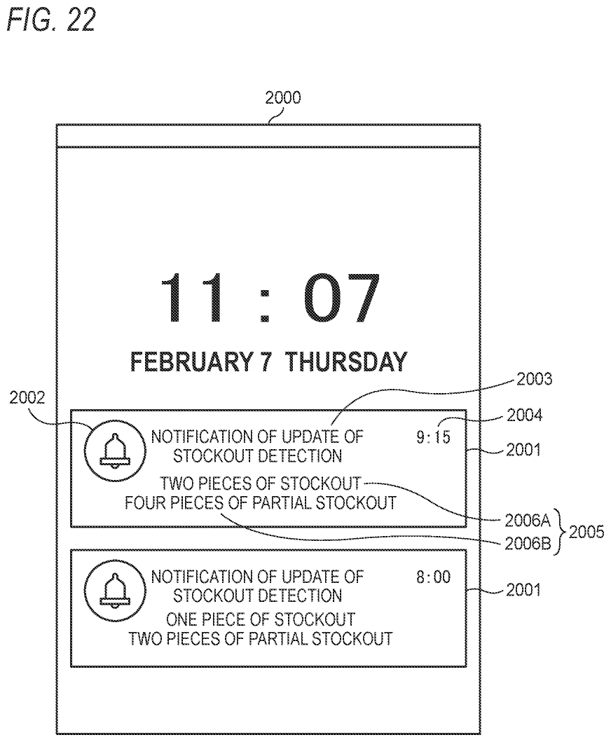

FIG. 22 is a diagram illustrating an example of a notification UI in the terminal 400. When the stockout notification is received from the business support device 300, the terminal 400 displays a notification UI 2000 on the display unit 405 as illustrated in FIG. 22.

The notification UI 2000 includes a notification image 2001. The notification image 2001 includes, for example, an icon 2002 indicating a stockout notification, a sentence 2003 indicating that stockout is detected, a time 2004 at which the stockout is detected, and information 2005 indicating a situation of the stockout.

The information 2005 indicating the situation of the stockout may include, for example, a number 2006A of full stockout and a number 2006B of partial stockout. The full stockout means that all commodities detected as stockout are out of stock in the display shelf. The partial stockout means that the commodities detected as stockout are partially out of stock in the display shelf. For example, among commodities arranged side by side in a plurality of columns, a case where a certain column is out of stock and/or a case where the number of commodities is smaller than a predetermined number or a space is referred to as the partial stockout.

An interval at which the business support device 300 performs the stockout notification to the terminal 400 may be longer than an interval at which the business support device 300 obtains information indicating stockout detection (hereinafter, referred to as “stockout detection information”) from the stockout detection device 200. For example, the business support device 300 obtains the stockout detection information from the stockout detection device 200 at intervals of 5 minutes. Then, the business support device 300 determines whether to perform the stockout notification based on the obtained stockout detection information, and when the business support device 300 determines to perform the stockout notification, the stockout notification is performed at a periodic timing (hereinafter, referred to as a “stockout notification timing”). The stockout notification timing may be set as a periodic time such as 0 minute, 15 minutes, 30 minutes, and 45 minutes every hour. Alternatively, the stockout notification timing may be set as a cycle such as an interval of 15 minutes or an interval of 30 minutes.

The business support device 300 may have a setting of performing the stockout notification within the business hours of a store (for example, between 8: 00 and 22: 00) and not performing the stockout notification outside the business hours of the store. In addition, at the stockout notification timing, the business support device 300 may collect a plurality of stockouts occurring in the store and perform the stockout notification. In addition, the business support device 300 may perform the stockout notification when the full stockout or the partial stockout is detected. Alternatively, the business support device 300 may perform the stockout notification when the full stockout is detected, and may not perform the stockout notification when the partial stockout is detected.

In addition, at the current stockout notification timing, the business support device 300 may not output again the notification of the stockout of which the notification has been output at the previous stockout notification timing. For example, when the same stockout detection information as the stockout detection information which has been obtained at the previous stockout notification timing is also obtained at the current stockout notification timing, the business support device 300 may exclude the same stockout detection information from the notification determination target.

By controlling the stockout notification as described above, the business support device 300 can prevent an excessive stockout notification from being performed to the terminal 400. Accordingly, since the usefulness and the reliability of the stockout notification to the terminal 400 are improved, the person in charge 2 can efficiently perform the business for the stockout (for example, the replenishment of out-of-stock commodities) through the stockout notification of the terminal 400. In addition, since the excessive stockout notification to the terminal 400 is prevented, it is possible to prevent a traffic load in the communication network 3.

The business support device 300 may determine whether to perform the stockout notification to the terminal 400 based on a plurality of pieces of latest stockout detection information obtained from the stockout detection device 200. For example, the business support device 300 may determine whether to perform the stockout notification by any one of the following determination methods 1 and 2.

<<Determination Method 1>>

When any of the two or more pieces of latest stockout detection information obtained from the stockout detection device 200 indicates “stockout is present”, the business support device 300 determines to perform the stockout notification to the terminal 400, and when any of the two or more pieces of stockout detection information indicates “stockout is absent”, the business support device 300 determines not to perform the stockout notification to the terminal 400. In addition, when at least one of the two or more pieces of stockout detection information is different from the other pieces of stockout detection information from the viewpoints of “stockout is present” and “stockout is absent”, the business support device 300 performs the same determination as the determination of the previous stockout notification.

For example, when any of the pieces of stockout detection information obtained at 10 minutes, 5 minutes, and 0 minutes before 12: 15 indicates “stockout is present”, the business support device 300 determines that the stockout notification is performed at the stockout notification timing of 12: 15, and when any of the pieces of stockout detection information obtained at 10 minutes, 5 minutes, and 0 minutes before 12: 15 indicates “stockout is absent”, the business support device 300 determines that the stockout notification is not performed at the timing of 12: 15. In addition, when the stockout detection information obtained 10 minutes before 12: 15 indicates “stockout is present” and the stockout detection information obtained 5 minutes and 0 minutes before 12: 15 indicates “stockout is absent”, the business support device 300 sets the determination of the stockout notification at the stockout notification timing (the current stockout notification timing) of 12: 15 as the same determination as the determination of the stockout notification at the stockout notification timing (the previous stockout notification timing) of 12: 00.

<<Determination Method 2>>

When a majority of the two or more pieces of latest stockout detection information obtained from the stockout detection device 200 indicates “stockout is present”, the business support device 300 determines to perform the stockout notification to the terminal 400, and when a majority of the two or more pieces of stockout detection information indicates “stockout is absent”, the business support device 300 determines not to perform the stockout notification to the terminal 400. Alternatively, when a predetermined number or more of the two or more pieces of latest stockout detection information obtained from the stockout detection device 200 indicates “stockout is present”, the business support device 300 determines to perform the stockout notification to the terminal 400, and when a predetermined number or more of the two or more pieces of stockout detection information indicates “stockout is absent”, the business support device 300 determines not to perform the stockout notification to the terminal 400. The latest stockout detection information may be prioritized, and the determination may be performed in consideration of the previous stockout detection information.

The “stockout is present” or “stockout is absent” indicated by the stockout detection information generated by the stockout detection device 200 may be incorrect due to the nature of image analysis. Therefore, as in determination methods 1 and 2 described above, by determining whether to perform the stockout notification based on the plurality of pieces of stockout detection information, the reliability of the stockout notification to the terminal 400 is improved.

<Map UI>

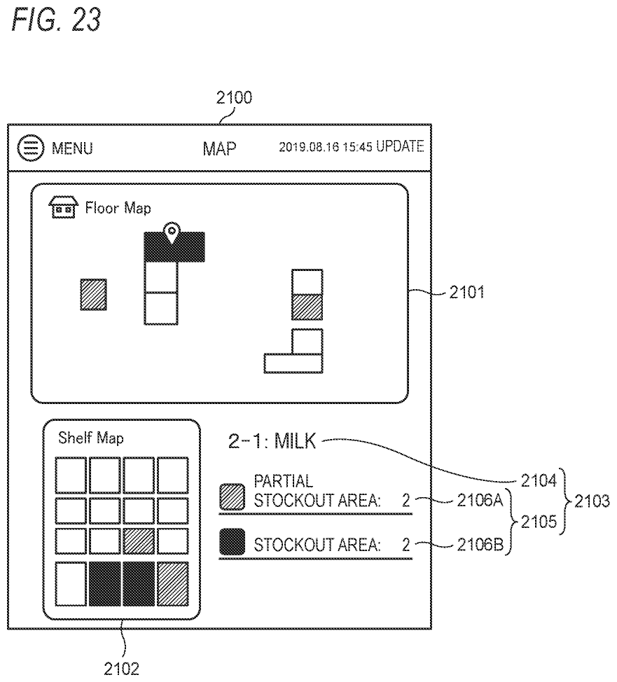

FIG. 23 is a diagram illustrating an example of a map UI in the terminal 400.

As illustrated in FIG. 23, the terminal 400 displays, on the display unit 405, a map UI 2100 indicating a position of a stockout shelf on a store floor and a position of a stockout section on the stockout shelf. The map UI 2100 includes a floor map image 2101, a shelf map image 2102, and out-of-stock commodity information 2103.

The floor map image 2101 indicates the position of the stockout shelf on the store floor. For example, as illustrated in FIG. 23, the floor map image 2101 indicates an arrangement of a display shelf on the store floor, and indicates the stockout shelf in a form different from that of another display shelf. The stockout shelf may be painted with a color or a pattern different from that of another display shelf. The stockout shelf of the full stockout may be painted in a color or a pattern different from that of the stockout shelf of the partial stockout. For example, as illustrated in FIG. 23, the stockout shelves of the full stockout are painted with black, and the stockout shelves of the partial stockout are painted with oblique lines.

The shelf map image 2102 indicates the position of the stockout section in the stockout shelf. For example, as illustrated in FIG. 23, the shelf map image 2102 indicates the stockout section in the stockout shelf in a form different from another section. The stockout section may be painted with a color or a pattern different from that of another section. The stockout section of the full stockout may be painted with a color or a pattern different from that of the stockout section of the partial stockout. For example, as illustrated in FIG. 23, the stockout sections of the full stockout are painted with black, and the stockout sections of the partial stockout are painted with oblique lines.

The stockout information 2103 indicates a name 2104 of a commodity category of an out-of-stock commodity and a stockout quantity 2105 of the out-of-stock commodity. For example, as illustrated in FIG. 23, in the stockout quantity 2105, a stockout quantity 2106A of the full stockout and a stockout quantity 2106B of the partial stockout are separately indicated.

<Notification List UI>

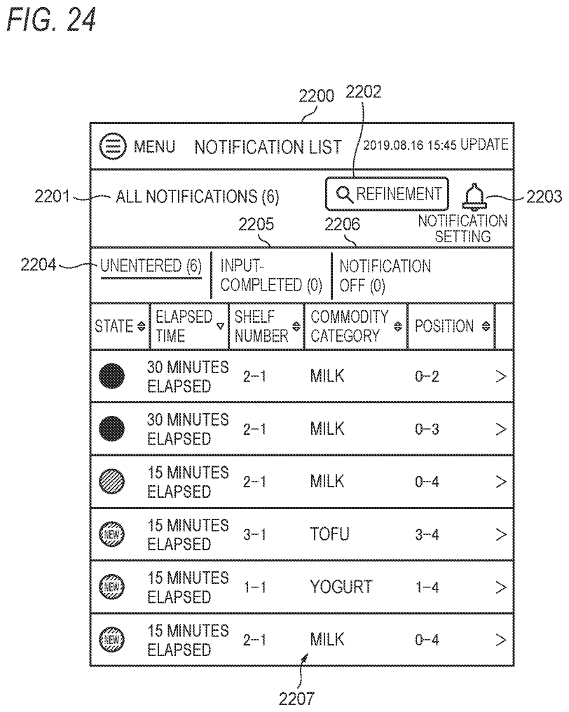

FIG. 24 is a diagram illustrating an example of a notification list UI in the terminal 400.

As illustrated in FIG. 24, the terminal 400 displays a notification list UI 2200 indicating a list of stockout notifications on the display unit 405. The notification list UI 2200 includes the number of notifications 2201 of the current day, a search refinement field 2202, a notification setting button 2203, an unentered tab 2204, an input-completed tab 2205, a notification off tab 2206, and a notification list 2207.

The number of notifications 2201 on the current day indicates the number of stockout notifications received on the current day by the terminal 400.

A search condition for narrowing down the notification list 2207 is input to the search refinement field 2202. For example, the search condition related to an elapsed time, a shelf number, or a commodity category corresponding to an item of the notification list 2207 may be input to the search refinement field 2202.

The notification setting button 2203 is a button for setting ON or OFF of the notification.

The unentered tab 2204 displays the notification list 2207 of a stockout notification on which no action has been performed. The number in parentheses of the unentered tab 2204 indicates the number of stockout notifications included in the notification list 2207 of the unentered tab 2204.

The input-completed tab 2205 displays the notification list 2207 of stockout notifications in which some action has already been performed. The number in the parentheses of the input-completed tab 2205 indicates the number of stockout notifications included in the notification list 2207 of the input-completed tab 2205.

The notification off tab 2206 displays the notification list 2207 of a stockout notification which has not been output due to the notification off setting. The number in parentheses of the notification off tab 2206 indicates the number of stockout notifications included in the notification list 2207 of the notification off tab 2206.

The notification list 2207 displays the stockout notifications in a list format. The notification list 2207 displays a state, an elapsed time, a shelf number, a commodity category, and a position as items related to the stockout notifications.
In the state, an icon based on the elapsed time from the reception of the stockout notification is displayed. For example, in the state, icons of different colors are displayed according to the elapsed time.
In the elapsed time, the elapsed time from the reception of the stockout notification is displayed.
In the shelf number, a shelf number of a stockout shelf is displayed. The shelf number corresponds to the shelf ID described in the first embodiment.
In the commodity category, a name of a commodity category of an out-of-stock commodity is displayed. Alternatively, a commodity name may be displayed in the commodity category.
In the position, a position of a stockout section in a stockout shelf is displayed.

<Notification Detail UI>

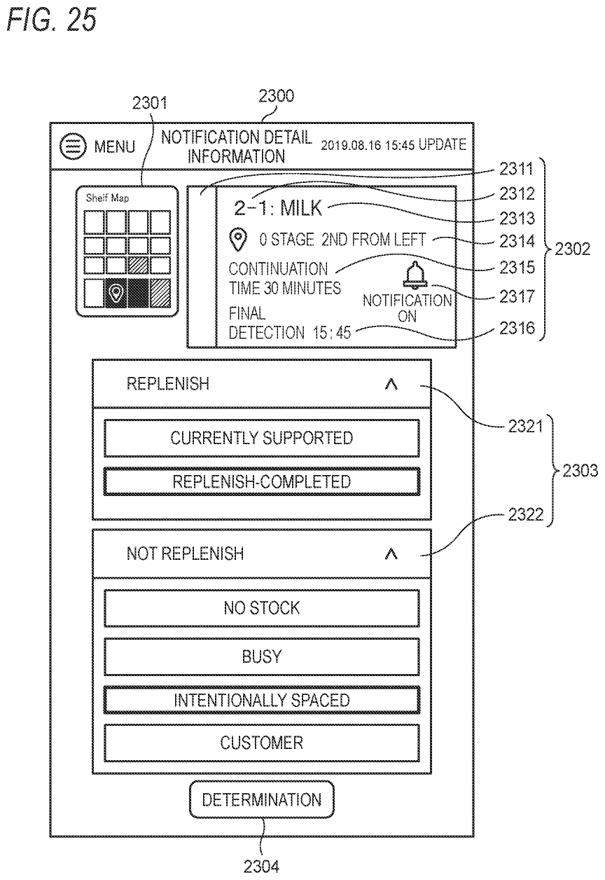

FIG. 25 is a diagram illustrating an example of a notification detail UI in the terminal 400.

When one stockout notification is selected in the notification list UI 2200, the terminal 400 displays, on the display unit 405, a notification detail UI 2300 indicating details of the selected stockout notification as illustrated in FIG. 25. The notification detail UI 2300 includes a shelf map image 2301, stockout notification detail information 2302, and an action input field 2303.

The shelf map image 2301 indicates a position of a stockout section in a stockout shelf.

The stockout notification detail information 2302 indicates detailed information related to the stockout notification. The stockout notification detail information 2302 indicates, for example, a color band 2311, a shelf number 2312, a commodity category 2313, a position 2314, an elapsed time 2315, a final detection time 2316, and a notification setting 2317.
The color band 2311 indicates whether the stockout notification is full stockout or partial stockout in a different color.
The shelf number 2312 indicates a shelf number of a stockout shelf.
The commodity category 2313 indicates a name of a commodity category of an out-of-stock commodity. Alternatively, the commodity category 2313 may indicate a commodity name.
The position 2314 indicates a position of a stockout section in a stockout shelf.
The elapsed time 2315 indicates an elapsed time from the reception of the stockout notification.
The final detection time 2316 indicates a final time at which the stockout is detected.
The notification setting 2317 is a button for setting ON or OFF of a notification for each commodity.

The action input field 2303 receives an input of an action for the stockout notification. For example, the action input field 2303 includes an option 2321 of “replenish” and an option 2322 of “not replenish”.
The option 2321 of “replenish” may further include sub options of “currently supported” and “replenish-completed”. In a case of replenishing the commodity corresponding to the stockout notification or in a case where the commodity is replenished, the person in charge 2 may select one of the sub options in the option 2321 of “replenish”.
The option 2322 of “not replenish” may further include sub options of “no stock”, “busy”, “intentionally spaced”, and “there is a customer”. In a case where the commodity corresponding to the stockout notification is not replenished or cannot be replenished, the person in charge 2 may select one of the sub options in the option 2322 of “not replenish”.

In response to the stockout notification, the person in charge 2 selects an appropriate option from the options included in the action input field 2303, and presses (touches) a determination button 2304. In this case, the terminal 400 transmits the content of the option selected by the person in charge 2 to the business support device 300 as an action of the person in charge 2 in response to the stockout notification. Accordingly, the business support device 300 can manage the action of the person in charge 2 in response to the stockout notification.

<Modification of Display Shelf>

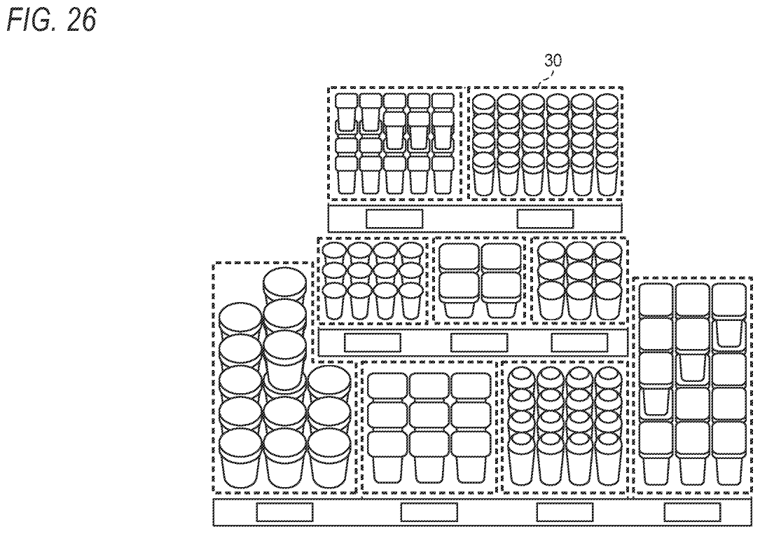

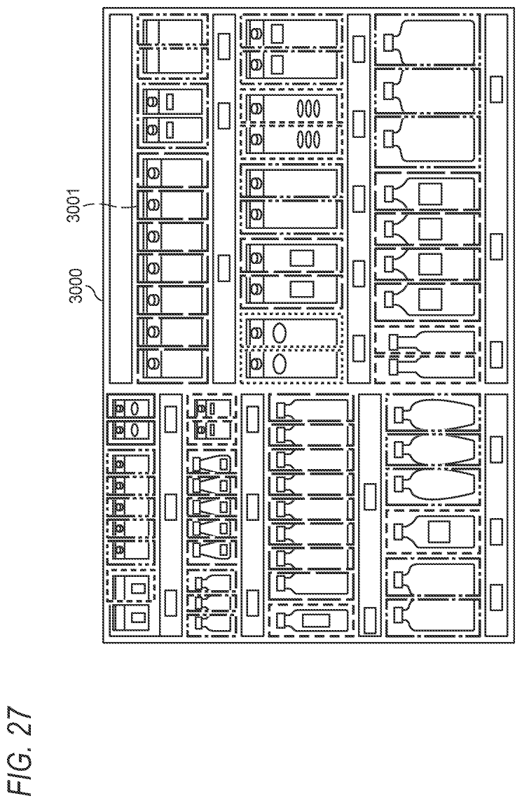

FIG. 26 is a diagram illustrating a modification of a display shelf.

A stockout detection system of the present disclosure is not limited to a type of the display shelf 10 in which commodities are arranged in a depth direction, and may be applied to a type of the display shelf 10 in which commodities are arranged or stacked on a plane as illustrated in FIG. 26. In this case, as illustrated in FIG. 26, the camera device 100 that captures an image of the display shelf 10 is disposed at a position in which the camera device 100 captures an image of the display shelf 10 from above. As illustrated in FIG. 26, the section 30 is set with respect to the display shelf 10 as viewed from above.

### Third Embodiment

In a third embodiment, an example in which the shelf allocation information 210 is automatically generated from the captured image of the display shelf 10 will be described. In the third embodiment, the same reference numerals are given to the contents described in the first or second embodiment, and the description thereof may be omitted. In the following description, the processing mainly described by the business support device 300 may be processing executed by the processing unit 301 of the business support device 300.

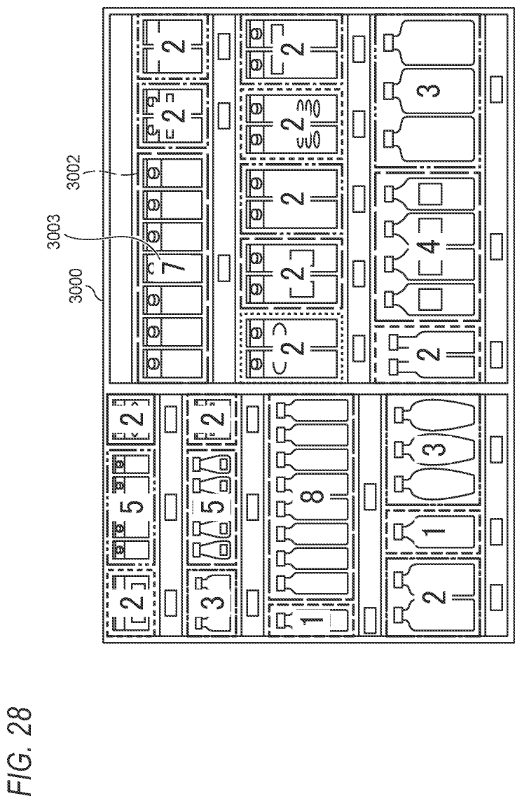

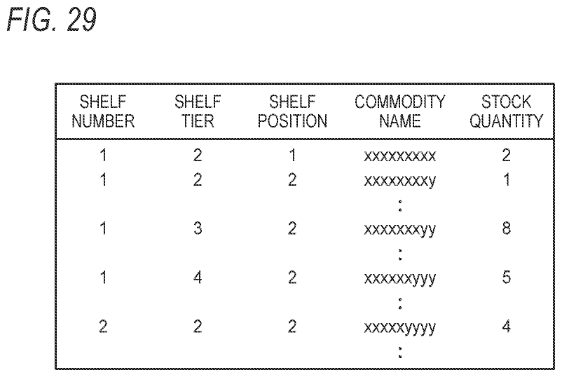

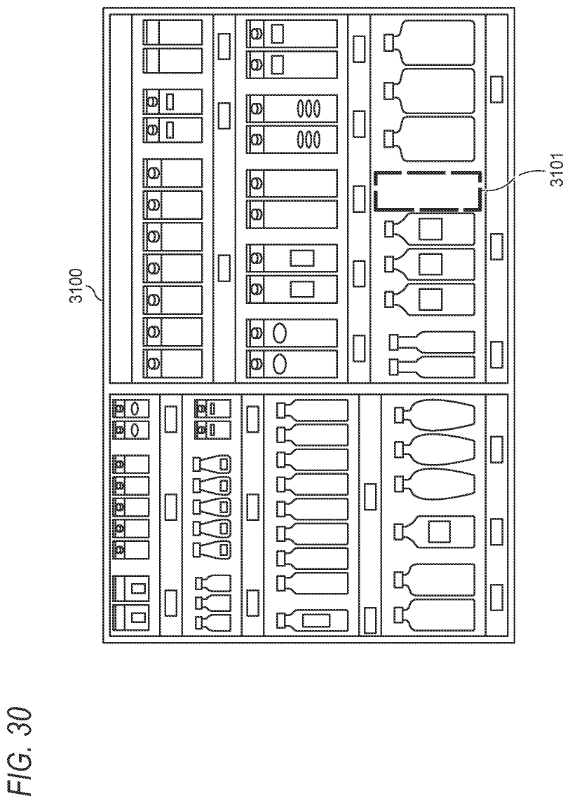

FIG. 27 is a diagram for describing an example of processing of detecting an appearance image of a commodity from an image obtained by capturing an image of a display shelf FIG. 28 is a diagram for describing an example of processing of generating the shelf allocation information 210 based on a detection result of the appearance image of the commodity. FIG. 29 is a diagram illustrating an example of the generated shelf allocation information 210.

The business support device 300 generates the shelf allocation information 210 by associating an appearance image of a commodity included in an image (hereinafter, referred to as a “first shelf image”) 3000 obtained by capturing an image of the display shelf 10 on which commodities are displayed without stockout and erroneous arrangement, commodity information such as a commodity name of the commodity indicated by the appearance image, and a position of an arrangement of the commodity indicated by the appearance image on the display shelf 10 with each other, and stores the shelf allocation information 210 into the memory 302. The shelf allocation information 210 may be generated from the captured image in this way, or may be generated in advance. In general, the shelf allocation information 210 called a realogram or a planogram may be prepared. For example, the business support device 300 generates the shelf allocation information 210 by the processing of the following steps S101 to S102.

(Step S101) The business support device 300 detects an appearance image of each commodity from the first shelf image 3000. At this time, as illustrated in FIG. 27, the business support device 300 may display, on the display unit 405 of the terminal 400, an image in which a frame 3001 surrounding the appearance image of each detected commodity is superimposed on the first shelf image 3000. As illustrated in FIG. 27, the business support device 300 may display the frame 3001 of the appearance image of the common commodity in a common form (for example, in the same color or pattern), and may display the frame 3001 of the appearance image of the different commodity in a different form (for example, in a different color or pattern). In FIG. 27, different forms of the frame 3001 of the appearance image are represented by different types of lines.

(Step S102) The business support device 300 stores the appearance image detected in step S101, the display position (for example, the section 30) of the commodity indicated by the appearance image on the display shelf 10, and the commodity name (commodity information, commodity ID, and the like) of the commodity indicated by the appearance image into the memory 302 in association with each other. At this time, as illustrated in FIG. 28, the business support device 300 may detect the number of columns (hereinafter, referred to as “the number of commodity columns”) of the same appearance image (that is, the same commodity) in the section 30. As illustrated in FIG. 28, the business support device 300 may display, on the display unit 405 of the terminal 400, an image (hereinafter, referred to as a “shelf allocation image”) in which a frame 3002 of the section 30 is superimposed on the first shelf image 3000 and the number of commodity columns 3003 in the section 30 is superimposed in the frame 3002 of the section 30. Here, since each section 30 is identified by the shelf number, the shelf tier, and the shelf position, as illustrated in FIG. 29, the business support device 300 may store, into the memory 302 as the shelf allocation information 210, a correspondence relationship between the shelf number, the shelf tier, and the shelf position (that is, the section 30) and the commodity name of the commodity indicated by the appearance image detected in the section 30 (generate and store a planogram from the captured image). As illustrated in FIG. 28, the business support device 300 may display frames of the different sections 30 in different forms (for example, different colors or patterns). In FIG. 28, different forms of the frame of the section 30 are represented by different types of lines. As illustrated in FIG. 29, the business support device 300 may include the stock quantity of each commodity into the shelf allocation information 210.

The business support device 300 generates the shelf allocation information 210 described above, for example, before the store opens. At this time, as described above, the business support device 300 may display, on the terminal 400 of the store manager, a shelf allocation image in which the frame 3002 of each section 30 and the number of commodity columns 3003 in the section 30 are superimposed on the first shelf image 3000 as illustrated in FIG. 28. Accordingly, the store manager can efficiently confirm whether the commodities are correctly displayed on the display shelf 10 before the store is opened, based on the shelf allocation image displayed on the terminal 400.

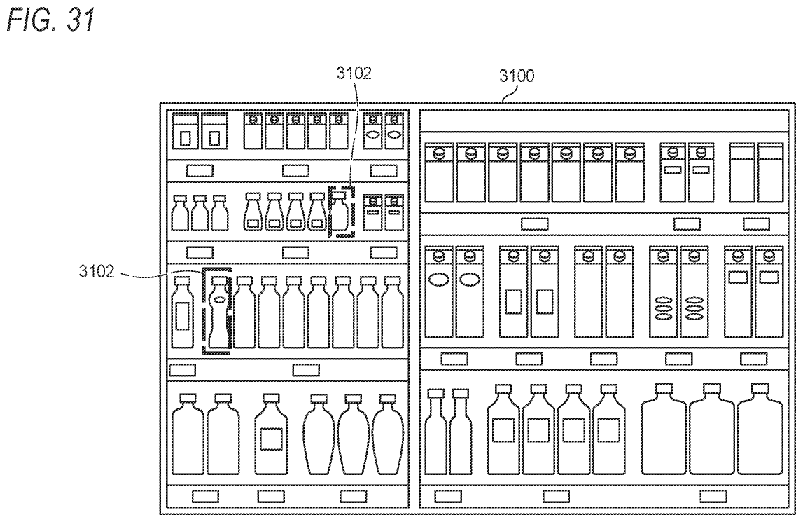

FIG. 30 is a diagram illustrating a display example of a shelf image in which stockout is detected. FIG. 31 is a diagram illustrating a display example of a shelf image in which an erroneous arrangement is detected.

The business support device 300 detects an appearance image stored in the memory 302 from an image (hereinafter, referred to as a “second shelf image”) 3100 obtained by capturing an image of the display shelf 10 after the first shelf image 3000, and controls a notification (for example, a stockout notification and/or an erroneous arrangement notification) related to the arrangement of the commodity indicated by the appearance image based on the detection result. Here, the erroneous arrangement means that the commodity is arranged in a section 30 different from the section 30 in which the commodity is supposed to be arranged. For example, the business support device 300 detects the stockout and the erroneous arrangement of the commodity, and performs the stockout notification and the erroneous arrangement notification by the processing of subsequent steps S201 to S203. The order of execution of the following steps S202 and S203 may be reversed.

(Step S201) The business support device 300 detects an appearance image of each commodity from the second shelf image 3100.

(Step S202) When it is detected that the commodity indicated by the appearance image stored in the memory 302 is not present at the position (for example, the section 30) of the arrangement of the commodity indicated by the appearance image indicated by the shelf allocation information 210 in the second shelf image 3100, the business support device 300 determines that the commodity indicated by the appearance image is out of stock. At this time, as illustrated in FIG. 30, the business support device 300 may display, on the display unit 405 of the terminal 400, a shelf image (hereinafter, referred to as a “stockout shelf image”) in which a frame 3101 surrounding a portion detected as stockout (hereinafter, referred to as a “stockout frame”) is superimposed on the second shelf image 3100. In addition, when it is determined that the commodity is out of stock, the business support device 300 may perform the stockout notification to the terminal 400 as described in the first or second embodiment.

(Step S203) When it is detected that the commodity indicated by the appearance image stored in the memory 302 is present at a position (for example, a different section 30) different from the position (for example, the section 30) of the arrangement of the commodity indicated by the appearance image indicated by the shelf allocation information 210 in the second shelf image 3100 (for example, when position information indicated by the shelf allocation information 210 is different from position information of the commodity illustrated in the captured second shelf image in a certain commodity), the business support device 300 determines that the commodity corresponding to the appearance image is erroneously arranged. At this time, as illustrated in FIG. 31, the business support device 300 may display, on the display unit 405 of the terminal 400, a shelf image (hereinafter, referred to as an “erroneous arrangement shelf image”) in which a frame 3102 surrounding the appearance image detected as the erroneous arrangement (hereinafter, referred to as an “erroneous arrangement frame”) is superimposed on the second shelf image 3100. In addition, when it is determined that the commodity is erroneously arranged, the business support device 300 may perform the erroneous arrangement notification in the same manner as the stockout notification described in the first or second embodiment.

Through the above processing, the business support device 300 can generate and display a stockout shelf image and an erroneous arrangement shelf image in which the positions of the stockout and the erroneous arrangement can be visually confirmed. The business support device 300 may superimpose the stockout frame 3101 and the erroneous arrangement frame 3102 on one second shelf image 3100. In this case, the stockout frame 3101 may be displayed in a form (for example, in a different color) different from that of the erroneous arrangement frame 3102. Accordingly, the business support device 300 can display a shelf image in which the positions of the stockout and the erroneous arrangement can be visually distinguished.

The business support device 300 performs the stockout notification described above within, for example, the business hours of the store. Accordingly, a store staff member can quickly notice the section 30 of the display shelf 10 in which the stockout has occurred through the terminal 400 during the business hours, and can quickly perform the stockout replenishment work. Therefore, it is possible to reduce the loss of sales opportunities in a store.

For example, the business support device 300 performs the above-described erroneous arrangement notification not only within the business hours of the store but also after the business hours of the store. Accordingly, the store staff member can quickly know the section 30 of the display shelf 10 in which the erroneous arrangement is present after the business hours, and can shorten the time taken to organize the display shelf 10.

An artificial intelligence (AI) technology may be used for the detection of the appearance image of the commodity described above. For example, the business support device 300 detects the appearance image of each commodity from the first shelf image 3000 and the second shelf image 3100 using a learning device that has learned the appearance image of each commodity in advance.

In addition, the processing of the business support device 300 described above may be read as the processing of the stockout detection device 200. Alternatively, the above-described processing of the business support device 300 may be read as cooperative processing of the business support device 300 and the stockout detection device 200.

The appearance image of the commodity described above is not limited to an appearance image of a package of a commodity, and may be an appearance image of an unpackaged commodity such as vegetables or fruits. In addition, the commodity of the display shelf 10 according to the present disclosure is not limited to a commodity of a supermarket, and may be, for example, a book in a bookstore, a component in a factory, or a cardboard in a warehouse.

In addition, when the business support device 300 detects an erroneous arrangement, the business support device 300 may transmit an erroneous arrangement notification to the terminal 400 as illustrated in FIGS. 10 and 24. At this time, it is preferable to display an erroneously arranged commodity (a misplaced commodity), a commodity to be placed in an erroneously arranged place (a commodity supposed to be arranged), and a place where the commodity is arranged thereafter (a position of the shelf and a position indicating a place in the shelf). When the terminal 400 receives the erroneous arrangement notification, the terminal 400 may display the notification image 2001 indicating the erroneous arrangement notification on the notification UI 2000 as illustrated in FIG. 22. In addition, when the terminal 400 receives the erroneous arrangement notification, the terminal 400 may display the position of the shelf in which the erroneous arrangement is detected in the map UI 2100 as illustrated in FIG. 23. The terminal 400 may display the UI as illustrated in FIG. 11 or 12 instead of the UI illustrated in FIG. 22 or 23. Accordingly, it is possible to issue an easy-to-understand instruction to the staff member in charge.

### Summary of Third Embodiment

The business support device (300) according to a third embodiment includes: the storage unit (302) that stores an appearance image of at least one article in the first shelf image (3000) obtained by capturing an image of the display shelf (10) of the article and a position of an arrangement of the article indicated by the appearance image on the display shelf in association with; and the processing unit (301) that detects the appearance image stored in the storage unit from the second shelf image (3100) obtained by capturing an image of the display shelf after the first shelf image is obtained, and controls, based on a detection result, a notification related to the arrangement of the article indicated by the appearance image. According to this configuration, the arrangement of the article in the second shelf image captured after the first shelf image is detected by using the appearance image detected from the first shelf image, and the notification related to the arrangement of the articles can be controlled based on the detection result. Therefore, the business support device can control the notification related to the arrangement of the article without manually generating the shelf allocation information indicating the correct arrangement of the article for the display shelf in advance.

When it is detected that the appearance image stored in the storage unit (302) is not present at the position of the arrangement associated with the appearance image in the second shelf image (3100), the processing unit (301) may output a notification that the article indicated by the appearance image is out of stock. The notification may include identification information of the article indicated by the appearance image and information indicating the detected position of the arrangement (that is, the position of the stockout). Accordingly, the business support device can perform the stockout notification to the terminal, for example, without manually generating the shelf allocation information indicating the correct arrangement of the article for the display shelf in advance.

When it is detected that the appearance image stored in the storage unit (302) is present at a position different from the position of the arrangement associated with the appearance image in the second shelf image (3100), the processing unit (301) may output a notification that the article indicated by the appearance image is arranged at an erroneous position. The notification may include identification information of the article indicated by the appearance image (identification information of the erroneously arranged commodity) and information indicating the detected different positions (that is, the position of the erroneous arrangement, the position of the shelf in the store, the area, the position in the shelf, and the like). Accordingly, the business support device can perform the erroneous arrangement notification to the terminal, for example, without manually generating the shelf allocation information indicating the correct arrangement of the articles for the display shelf in advance.

Although the embodiment has been described with reference to the accompanying drawings, the present disclosure is not limited to such an example. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, the constituent elements in the above-described embodiment may be combined as desired without departing from the scope of the invention.

The present application is based on Japanese Patent Application No. 2019-207988 filed on Nov. 18, 2019, and the contents thereof are incorporated herein by reference.

### INDUSTRIAL APPLICABILITY

The present disclosure is applicable to a system that supports a business related to stockout.

### REFERENCE SIGNS LIST

10: display shelf
11: shelf plate
12: display space
20: shelf label
30: section
100: camera device
200: stockout detection device
201: processing unit
202: memory
203: communication unit
204: storage
205: internal bus
210: shelf allocation information
300: business support device
301: processing unit
302: memory
303: communication unit
304: storage
305: internal bus
310: management information
400: terminal
401: processing unit
402: memory
403: communication unit
404: input unit
405: display unit
406: storage
407: internal bus
900: login UI
910: service menu UI
1000: stockout information UI
1100: shelf map UI
1200: display shelf UI
1300: shelf map UI
1400: display shelf UI
1500: order history UI
1600: shelf map UI
1700: shelf allocation advice UI
1800: shelf allocation change UI
1900: price change UI
2000: notification UI
2100: map UI
2200: notification list UI
2300: notification detail UI
3000: first shelf image
3001: frame of appearance image
3002: frame of section
3003: the number of commodity columns
3100: second shelf image
3101: stockout frame
3102: erroneous arrangement frame

1. A business support device comprising:
a storage that stores an appearance image of an article included in a first shelf image obtained by capturing an image of a display shelf of the article and a position of an arrangement of the article indicated by the appearance image on the display shelf in association with each other; and
a processor configured to detect the appearance image stored in the storage from a second shelf image obtained by capturing an image of the display shelf after the first shelf image is obtained, and control a notification related to the arrangement of the article indicated by the appearance image based on a detection result.

2. The business support device according to claim 1,
wherein the processor is configured to output a notification that the article indicated by the appearance image is out of stock in a case in which it is detected that in the second shelf image, the appearance image stored in the storage unit is not present at the position of the arrangement associated with the appearance image.

3. The business support device according to claim 2,
wherein the notification comprises identification information of the article indicated by the appearance image and information indicating a detected position of the arrangement.

4. The business support device according to claim 1,
wherein the processor is configured to output a notification that the article indicated by the appearance image is arranged at an erroneous position in a case in which it is detected that in the second shelf image, the appearance image stored in the storage unit is present at a position different from the position of the arrangement associated with the appearance image.

5. The business support device according to claim 4,
wherein the notification comprises identification information of the article indicated by the appearance image and information indicating a detected different position.

6. A business support method comprising:
storing, in a storage, an appearance image of an article included in a first shelf image obtained by capturing an image of a display shelf of the article and a position of an arrangement of the article indicated by the appearance image on the display shelf in association with each other; and
detecting the appearance image stored in the storage from a second shelf image obtained by capturing an image of the display shelf after the first shelf image is obtained, and controlling a notification related to the arrangement of the article indicated by the appearance image based on a detection result.

7. A non-transitory computer-readable medium storing instructions that, when executed by a processor, cause a computer to execute the business support method according to claim 6.

8. A business support system comprising:
the business support device according to claim 1; and
a terminal configured to display a content of the notification in response to reception of the notification.

9. A business support device comprising:
a storage that stores shelf allocation information generated by using a first shelf image obtained by capturing an image of at least a display shelf of an article and in which at least commodity information of the article and information of the display shelf are associated with each other, and an appearance image of the article displayed on the display shelf; and
a processor configured, in a case in which it is detected that in a second shelf image obtained by capturing an image of the display shelf after the first shelf image is obtained, the article of the appearance image stored in the storage is present at a position different from a position of an arrangement based on the shelf allocation information, to output a notification of information indicating that the article indicated by the appearance image is arranged at a different position and information indicating a position of a display shelf in which the article is arranged at the different position, the position of the display shelf being specified based on information of the display shelf in which the article is arranged at the different position and shelf arrangement information indicating an arrangement of the display shelf.

10. The business support device according to claim 9,
wherein the processor is configured to output a notification that the article indicated by the appearance image is out of stock, when it is detected that the appearance image stored in the storage is not present at the position of the arrangement associated with the appearance image in the second shelf image.

11.-12. (canceled)

13. A business support system comprising:
the business support device according to claim 9; and
a terminal configured to display a content of the notification in responses to reception of the notification.

14.-17. (canceled)
